(19) United States
(12) Patent Application Publication
(10) Pub. No.: US 2011/0060551 A1
(43) Pub. Date: Mar. 10, 2011

(54) APPARATUS FOR MEASURING DEPTH OF A HYDROPHOBIC LIQUID ON THE SURFACE OF WATER AND METHOD FOR SAME

(75) Inventor: Imad H. Elhajj, Beirut (LB)

(73) Assignee: American University of Beirut, Beirut (LB)

(21) Appl. No.: 12/856,364

(22) Filed: Aug. 13, 2010

Related U.S. Application Data
(60) Provisional application No. 61/233,818, filed on Aug. 13, 2009.

(51) Int. Cl. G01B 11/22; G06F 15/00

(52) U.S. Cl. 702/166; 356/625

(57) ABSTRACT

The present invention relates to a device and method for measuring depth of a hydrophobic liquid, such as oil, on a surface of water. The device uses a conductivity sensor and/or an optical sensor to detect the depth of an oil-water boundary. The device may have a Global Positioning System (GPS) for determining the geographic position of the device. Measurements of oil depth taken at particular geographic locations may be transmitted in real-time by the device to a remote computer in order to generate a depth profile of an oil spill.

### CROSS-REFERENCE TO RELATED APPLICATIONS

The present application claims priority from U.S. Provisional Patent Application Ser. No. 61/233,818, filed on Aug. 13, 2009, which is hereby incorporated in its entirety.

### FIELD OF THE INVENTION

The present invention relates to a device and method for measuring depth and location of a hydrophobic liquid on a surface of water. In particular, the present invention relates to the field of environmental remediation in sea and fresh water shipping lanes as well as any body of sea or fresh water that is adjacent to industrial quantities of oil that are stored, transported, refined, or used. More particularly, the present invention is directed at a device for and a method of affecting the mapping and quantization of spilled oil in such marine locations irrespective of the conditions of wind, waves, or light.

### BACKGROUND OF THE INVENTION

It is generally known that oil spills damage the environment, harming both flora and fauna. Oil spills can be caused by pipeline leaks, off-shore drilling operations, oil tanker spills, failure of storage containers and refinery handling, and ship and car maintenance operations. Birds and mammals caught by an oil spill try to clean themselves and, in the process, absorb oil that can lead to death or introduction of the contaminating oil into the food chain. Fish in the vicinity of an oil spill take in oil when breathing through their gills. Effects upon biodiversity beyond the immediate vicinity of an oil spill can be felt due to the accumulation of subtoxic (but nonetheless deleterious) and toxic levels of oil in the food chain. For example, a predator, though not directly exposed to an oil spill, may eat oil-tainted organisms, such as fish, and end up harmed even though the oil-tainted fish individually managed to withstand the oil insult. Such predators include humans.

An oil spill is typically not static. Even in the absence of wind or water currents, an oil spill will tend to spread along the surface of the water due to gravity and the respective properties of oil and water. With the impact of air and water currents, an oil spill may spread quickly and thus become very thin in broad areas. As its thickness decreases, an oil spill becomes more difficult and expensive to remove from water. As a result, it is commonly the case that only about 20% of the total quantity of any oil spill is recovered.

The thickness of an oil spill is often non-uniform over the area covered by the oil spill. Knowing the location(s) where an oil spill has a sufficient depth that facilitates the clean-up effort adds value by informing management of a clean-up effort to make better tactical decisions regarding where to direct resources of containment and recovery, for example. With such, the clean-up operations can be focused at locations where the oil thickness is more efficiently recovered. Furthermore, given the fast-spreading nature of an oil spill, effective management of the clean-up operation can direct crews using real-time measurements of oil depth in various locations in order to coordinate and optimize the clean-up operation.

Measurements of oil thickness may be taken with remote sensors or direct-contact sensors, each of which has distinct benefits and drawbacks. Radar sensors can detect the thickness of an oil spill from a remote location, but suffer from having a limited range, measurements distorted by lighting and wave conditions, and high cost. Direct-contact sensors that, for example, float on top of the spilled oil, may be more accurate, however, existing direct-contact sensors are typically large in size and weight and thus difficult to deploy in an oil spill.

In view of how existing technology is deployed for oil spill measurements, there is a need for a direct-contact oil depth sensor that can take accurate measurements that are unaffected by varying environmental conditions that are characteristic of the ocean, for example. Such variables include, without limitation intended, wave conditions, lighting conditions, salinity conditions, and temperature conditions. Furthermore, a need exists for an oil depth sensor that can be deployed at various locations in an oil spill and can communicate the depth of the oil at those locations and, particularly, changes in the oil depth over time at those locations in real-time.

### SUMMARY OF THE INVENTION

The present invention is directed at a device and method for measuring and mapping certain aspects, such as depth, of a hydrophobic liquid located on a surface of water. The device can be deployed in an oil spill on a body of water, such as a lake, sea, ocean, or river and provide accurate measurements unaffected by environmental conditions such as waves, wind, temperature, salinity, and light. The device can be predominantly buoyant in any liquid wherein a portion of the device is submerged below the surface of the oil and/or water. The device can have sensor columns that extend between the submerged portion of the device and the surface of the oil and/or water. The sensor columns can have conductivity or optical sensors, or both conductivity and optical sensors, to measure the depth of an oil spill. By measuring the conductive properties of a liquid in which the device is submerged, the conductivity sensors can identify the type of liquid. The optical sensors can identify the type of liquid in which the device is submerged by measuring the spectral properties of the liquid. The device can use information collected by the conductivity and/or optical sensors to determine an oil-water boundary and thereby measure the depth an oil spill.

The conductivity sensor can have two non-contacting surfaces where the liquid in which the device is submerged can pass between the two non-contacting surfaces. A known voltage can be applied to one surface and another voltage can be measured at the other surface. The device can use the difference between the known voltage and the measured voltage to determine the conductive properties of the liquid between the two surfaces. One surface of the conductivity sensor can have a plurality of longitudinally arranged conductive strips where each conductive strip is disposed at a different depth in the liquid. This configuration can allow the conductivity sensor to make conductivity measurements at different depths.

The optical sensor can have a light source and light receiver where the liquid in which the device is submerged can pass between the light source and light receiver. Light emitted by the light source passes through the liquid before being incident upon the light receiver. The light receiver can be a light dependent resistor such that electrical resistance of the light receiver varies with the intensity of the light incident upon the light receiver. The device measures the electrical resistance of the light receiver to determine the spectral properties of the liquid between the between the light source and the light receiver. The optical sensor can have a plurality of longitudinally arranged light source and light receiver pairs where each pair is disposed at a different depth in the liquid. This configuration can allow the optical sensor to make measurements at different depths.

The submerged portion of the device can have a waterproof enclosure containing electronic circuitry for controlling and powering the device's sensors. The device can have a GPS system for determining the device's geographic location and a wireless transceiver for communicating data collected by the device with an external receiver.

Other objects of the present invention, as well as particular features, elements, and advantages thereof, will be elucidated or become apparent from, the following description, appending claims, and the accompanying drawing FIGS.

### BRIEF DESCRIPTION OF THE DRAWINGS

FIG. 1 is a three-dimensional view of an embodiment of the present invention.

FIG. 2 is a circuit diagram for a circuit useful in a conductivity sensor.

FIG. 3 is a circuit diagram for a circuit useful in an optical sensor.

FIG. 4 is a flowchart for an algorithm useful in converting voltage measurements taken by a conductivity sensor into information regarding depth of oil.

FIG. 5 is a flowchart for an algorithm useful in converting voltage measurements taken by an optical sensor into information regarding depth of oil.

FIG. 6 is a block diagram for electrical connections between elements of the present invention of FIG. 1.

FIG. 7 is a block diagram for electrical connections between elements of another embodiment of the present invention.

FIG. 8 is a block diagram for electrical connections between elements of a further embodiment of the present invention.

FIG. 9 is a plot of experimental data for thickness measurements made using an optical sensor in a light environment.

FIG. 10 is a plot of experimental data for thickness measurements made using the optical sensor of FIG. 9 in a dark environment.

FIG. 11 is a plot of experimental data for thickness measurements made using a conductivity sensor in fresh water.

FIG. 12 is a plot of experimental data for thickness measurements made using the conductivity sensor of FIG. 11 in salt water.

FIG. 13 is a plot of experimental data for thickness measurements made using the optical sensor of FIG. 9 for various temperatures.

FIG. 14 is a plot of experimental data for thickness measurements made using the conductivity sensor of FIG. 11 for various temperatures.

FIG. 15 illustrates back to front tilting of an optical sensor.

FIG. 16 illustrates right to left tilting of an optical sensor.

FIG. 17 is a plot of experimental data for thickness measurements made using the optical sensor of FIG. 9 while the optical sensor had a right to left tilt.

FIG. 18 is a plot of experimental data for thickness measurements made using the optical sensor of FIG. 9 while the optical sensor had a back to front tilt.

FIG. 19 illustrates back to front tilting of a conductivity sensor.

FIG. 20 is a plot of experimental data for thickness measurements made using the conductivity sensor of FIG. 11 while the conductivity sensor had a right to left tilt.

FIG. 21 is a plot of experimental data for thickness measurements made using the conductivity sensor of FIG. 11 while the conductivity sensor had a back to front tilt.

The foregoing and other features and advantages of the disclosure are apparent from the following detailed description of exemplary embodiments, read in conjunction with the accompanying drawings; wherein like structural or functional elements may be designated by like reference numerals.

### DETAILED DESCRIPTION OF THE PREFERRED EMBODIMENTS

The present invention is directed to a device that can be deployed in an oil spill on a body of water, such as a lake, sea, ocean, or river for the purpose of measuring certain aspects of the spilled oil. More specifically, the invention is directed to a sensory device that uses conductivity and/or optical sensors to measure the depth of an oil spill.

Oil, of course, is well known to separate from water in view of its hydrophobic (literally, water-avoiding) nature. Oil is also less dense than water and, therefore, even highly dispersed oil ultimately rises to the surface of the water. On the water's surface, the oil collects and thereby manifests a depth of oil located over a definable area. Over time, forces of gravity, water, and air currents may cause the area of oil coverage to expand unless the oil is contained and removed efficiently. Even if the spill area is contained, the location of the spill may change due to water currents and winds. For effective management of the clean-up operation after an oil spill, it is critical to have regularly updated information on the depth and location of an oil spill as it may indeed vary with time after the event that resulted in the spill. Such information includes the rates at which location and depth change over time, as well as the location of the spilled oil.

It is important to remove spilled oil quickly from water in natural waterways for more than aesthetic reasons. Water below a surface depth of oil is separated from the atmosphere, thereby depriving wildlife in the water below of normal oxygen levels. The spilled oil also impacts airborne life, such as birds, that may inadvertently become covered in the oil causing them to remain on the ground or in the water/oil spill area. As noted above, oil-tainted flora and fauna can persist in the biosphere thereby spreading oil toxicity throughout the food chain.

Depth of oil on water may be defined as a distance between an upper surface of the oil that contacts the atmosphere and a lower surface of the oil that contacts the water. The present invention is designed to measure the depth of an oil spill and identify the location thereof. The present invention further measures rates at which the oil spill is expanding or relocating its area of coverage over the water. Such measured data of depth and location can be provided to a remote site for management, thereby facilitating deployment decisions for containment and clean up operations. The efficiency of collecting such information is increased, of course, with the use of multiple devices designed in accordance with the present invention, thereby fostering measurements of the depth and location of an oil spill at a plurality of locations. Depth and location data collected by the device or devices may be transmitted wirelessly in real-time or at intervals by the device to a remote computer and management decisions can then flow from further analysis of such data streams.

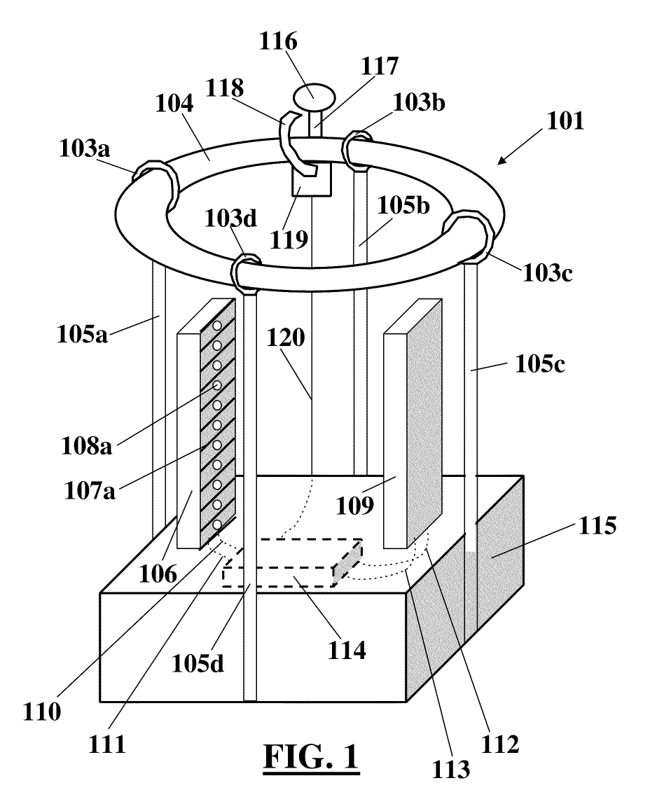

Referring to FIG. 1, an embodiment of a device 101 includes sensory instruments for detecting the presence of oil and/or water at different depths. The device 101 is predominantly buoyant in any liquid where a portion of the device 101 is submerged below a surface of the liquid contacting the atmosphere. The device 101 includes a flotation structure 104 having a density less than water in order to maintain buoyancy of the device 101.

In one embodiment, the flotation structure 104 is made from buoyant material in the form of an inflatable tube having, as illustrated in FIG. 1. In other embodiments, the floatation structure 104 is made from an inherently buoyant material that may or may not have a hollow design. For example, the buoyant material may be constructed from a hydrophobic material, such as an organic polymer that preferentially adheres to oil (and excludes water) such that the device 101 maintains contact with the oil. In addition, the flotation structure 104 may have any color and/or shape as desired, including having a color and/or shape that is easily identifiable from a distance. For example, the flotation structure 104 may have a generally circular shape, as illustrated in FIG. 1, or the flotation structure 104 may have other shapes, including by way of example and not limitation, any two dimensional polygonal shape or any three dimensional shape designed to be visible from a distance as may be known in the art.

In one embodiment, a waterproof enclosure 115 is connected to the flotation structure 104 and may contain electronic circuitry for any of the purposes of data processing, communication, and/or GPS data acquisition. The waterproof enclosure 115 may be constructed from a rigid, non-corrosive material such as plexiglass or a corrosion-resistant metal (whether inherently so or treated to be so). The waterproof enclosure 115 is attached to the flotation structure 104 by one or more support members 105, for example, four support members 105a-105d, as illustrated in FIG. 1.

In this embodiment, the support members 105a-105d rigidly attach the flotation structure 104 to the waterproof enclosure 115. Other embodiments include support members 105a-105d that are inherently flexible, thus allowing for variablilty in the position of the flotation structure 104 relative to the waterproof enclosure 115. Such inherently flexible support members 105a-105d lessen the likelihood that one or more of the support members 105a-105d might snap. It is contemplated that three or more support members 105 may provide a generally stable relative configuration of the enclosure 115 and the flotation structure 104.

In another embodiment, the support members 105 may be interconnected by truss members (not shown) in order to increase stability and strength of the device 101. A truss-like configuration may allow for a decrease in material required to construct the support members 105 while maintaining strength and durability of the device 101. Smaller support members 105 may be advantageous in that oil may freely communicate between the waterproof enclosure 115 and the floatation structure 104. Such free communication of the oil may be significant because oil that becomes stagnant between the waterproof enclosure 115 and the floatation structure 104 due to obstruction by large support members may result in inaccurate depth measurements of the oil. FIG. 1 illustrates the four support members 105a-105d that may be made from a variety of suitable materials including, by way of example and not limitation corrosion-resistant material, such as a galvanized steel or a suitably stiff but flexible plastic, metal, a blended composite, etc.

Each support member 105a-105d is attached to the floatation structure 104. In the embodiment depicted in FIG. 1, each support member 105a-105d is wrapped around the floatation structure 104, as shown at locations 103a-103d, respectively. In another embodiment, the support members 105a-105d may be integrally formed with the flotation structure 104 and manufactured, for example, by injection molding or die casting. The support members 105a-105d may be fastened to the waterproof enclosure 115 by any of a variety of fastening means as known in the art, including by way of example and not limitation, a screw, a strap, a clip, a cotter pin, a weld and/or an adhesive (not shown).

Referring to FIG. 1, the device 101 includes an electrical conductivity sensor 107 and/or or an optical sensor 108 to determine the depth of spilled oil in a marine environment. First and second components 107a, 107b of the electrical conductivity sensor 107 are disposed on first and second sensor columns 106, 109 respectively. Similarly, first and second components 108a and 108b of the optical sensor 108 are disposed on the first and second sensor columns 106, 109 respectively. In other embodiments, more than two sensor columns may be utilized, if desired. For example, the first and second sensor columns 106, 109 could accommodate the electrical conductivity sensor first and second components 107a, 107b, respectively, and a second pair of columns, for example, third and fourth sensor columns could accommodate the optical sensor first and second components 108a, 108b, respectively.

The sensor column 106 may include the conductivity sensor first components 107a and the optical sensor first components 108a and the sensor column 109 may include the conductivity sensor second components 107b and the optical sensor second components 108b. In one embodiment, the electrical conductivity sensor components 107a, 107b may be distributed conductivity sensor strips or plates. The optical sensor components 108a, 108b may be light emitters and receivers disposed on the first and second sensor columns 106, 109, respectively.

In use, the sensor columns 106 and 109 extend from a top surface of the waterproof enclosure 115 to about the surface of the oil and/or water to about the point of contacting the atmosphere. In this configuration the sensor columns 106, 109 are substantially orthogonal to the surface of the water and/or oil contacting the atmosphere.

In one embodiment, the conductivity sensor second components 107b can be a single component that extends the entire length of the column 109. Moreover, in view of the properties of electricity, the conductivity sensor first components 107a or the conductivity sensor second component(s) 107b can be placed on any surface of the first and second sensor columns 106, 109, respectively. The conductivity sensor first and second components 107a, 107b may be configured in any orientation, for example, facing each other or facing away from each other, as long as the shortest distance of electrical communication between the first components 107a and the second component(s) 107(b) is substantially the same for all of the first and second components 107a, 107b. In contrast, the optical sensor second components 108b are paired to the respective optical sensor first components 108a by level and face each other.

The first and second components 107a, 107b of the electrical conductivity sensor 107 are formed of an electrically conductive material. Any suitably electrically conductive material can be used, including by way of example and not limitation, copper, silver, lead, or an alloy such as bronze. The conducting strips are preferably formed from a material that does not quickly undergo electrolysis in water, such as metal and/or a metal alloy containing mercury and/or carbon, to name a few suitable species. The suitable electrically conductive material can be layered with differing elements or alloys, such as, for example, tin-plated copper or bronze. Particularly suitable electrically conductive materials are those that efficiently conduct electricity and can be formed into flexible wires. In one embodiment, the electrically conductive material is predominantly copper for insulated wires. In another embodiment, the electrically conductive material is tin-plated copper for conductive strips and plates.

In one embodiment of the device 101, the waterproof enclosure 115 is completely submerged in use beneath a surface of water and/or oil. The design illustrated by FIG. 1 may benefit buoyancy and stability of the device 101 because a majority of mass of the device 101 is disposed at a bottom of the device 101 within the waterproof enclosure 115. Accordingly, this design results in the device 101 having a center of gravity located beneath the surface of the water and/or oil and therefore inhibits the orientation of the device 101 from straying from vertical. This design, moreover, lessens the likelihood of the device 101 tipping, capsizing, or turning “turtle” where the device 101 becomes inverted. Furthermore, this design heightens the likelihood of accurate measurements of oil depth irrespective of environmental conditions such as wave conditions, lighting conditions, salinity conditions, temperature conditions and wind conditions.

In other embodiments, the waterproof enclosure 115 is suspended from three or more support members 105 that extend above the flotation structure 104 and thereby keep the waterproof enclosure 115 above the surface of the water and/or oil. Such a configuration would likely include additional weight contained in or connected to and/or below the flotation structure 104 to promote stability of the device 101 with a center of gravity that is at or below the surface of the water and/or oil. The sensor columns 106 and 109 may extend downward from a bottom surface of the waterproof enclosure 115 into the water and/or oil. These embodiments may ensure that wireless communications sent from the waterproof enclosure 15 are not distorted by having to travel through oil and/or water. Furthermore, these embodiments facilitate the incorporation of solar panels onto the waterproof enclosure 15 such that the device 101 may be powered by solar energy.

The conductivity sensor 107 is preferably a passive sensor that detects the difference in electric conductivity properties of different solutions. The conductivity of water is dependent on the concentration of dissolved salts and other chemicals ionized within the water. Since sea water possesses a high electric conductivity and oil possesses a low electric conductivity, the current passing through sea water may be high relative to the current passing through oil for a given potential difference. Therefore, a longitudinal array of conductive metal pairs disposed across a pair of conductivity sensor columns, for example the first and second sensor columns 106, 109 illustrated in FIG. 1 is particularly suitable for the device 101. Such a configuration is similar to that of the longitudinal array of LED-LDR pairs further described hereinbelow.

In one embodiment, the second sensor column 109, or second plate 109, is fully covered with conductive material and connected to ground. The conductive material extends along at least one length of at least one face of the sensor column 109. The first sensor column 106, or first plate 106, is covered with equidistant strips 107a of the same conductive material, fed by a constant voltage and separated by strips of non-conductive material having the same or greater thickness than the conductive material. Each strip of conductive metal on the first sensor column 106 and the fully-conducting plate 109 makes up a conductive metal pair, separated by oil and/or water. By determining the level of the current passing between each conductive pair, one can detect the presence of oil at a corresponding depth.

As in the case of the light sensor described below, the level of current passing between the first and second plates 106, 109 is determined from measured voltages. Each conductive pair is connected to a resistor (R_{D}) to transform the measured current to voltage. R_{D} should have a small resistance value in order not to attain high voltages at the A/D input of the microcontroller.

Since the aqueous solution between each conductive pair does not act like a perfect switch, where it is on in the case of water and off in the case of oil, it is preferred to measure conductivity using resistance, where the aqueous solution acts like a resistor that has high resistance in the case of oil and low resistance in the case of water. Therefore, measuring the voltage on R_{D} is similar to the voltage divider configuration used for the light sensor, which is discussed below. However, no initial calculation (to convert voltage into current level) is needed because the measured voltage is substantially linear to the current level, which is required for the analysis. In order to prevent ground looping, which can be caused by the existence of a large number of resistors in series with each metal strip, in some embodiments the resistors are connected to a multiplexer, through which only one of the resistors is connected to ground at one time.

The optical sensor 108 is an active optical sensor where the variation in intensity of transmitted light is detected and measured. The first optical components 108a of the optical sensor 108 are light sources disposed on one of the first and second sensor columns 106, 109. The light sources emit any or all visible or near-visible wavelengths. Particularly suitable wavelengths to use are those that exhibit very low absorption in water but high absorption in oil. In one embodiment, a blue light having a wavelength between about 440 nm and 490 nm is used. In other embodiments, light of any of the primary colors, or a combination of some or all of them, in any combination of intensities thereof, may be employed.

The light source itself can be a light-emitting diode (LED) or any other low-voltage powered light source. The light source can be a single source of light or a plurality of individual light sources arranged along the first or second sensor column 106, 109. The light source can be configured to provide intermittent bursts of light or continuous illumination of light. In some embodiments, the light source is the aforementioned LED having a discrete size of, for example, a diameter of about 1 mm up to and including a diameter of about 25 mm; preferably the diameter of the LED is from about 2 mm to about 15 mm; more preferably the diameter of the LED is from about 3 mm to about 7 mm. In an embodiment where the entire first or second sensor column 106, 109 contains the light source, the light source has a length that spans the length of the first or second sensor column 106, 109 and is, for example, without limitation, about 50 cm in length; in other embodiments, the column-spanning light source has a length of about 40 cm, of about 30 cm, or of about 20 cm. The light source for any of the embodiments discussed herein can comprise any visible light emitting technology such as, without limitation, incandescent, fluorescent, or LED.

The second components 108b of the optical sensor are any light detectors that generate a signal that can be detected and interpreted by a processor in response to light impinging on the detector. Suitable light detectors include, by way of example and not limitation, light-dependent resistors (LDRs) and photodiodes. These light detectors 108b (LDs) are attached to the first or second sensor column 106, 109 at identified points along the length thereof. Accordingly, when an LD 108b detects light from a light source 108a attached to the opposite sensor column (106 or 109), the processor interprets the signal generated by the LD 108b. The processor determines whether there is a change in the light transmission characteristics of the liquid that is disposed between the first and second optical sensor columns 106, 109.

The closer the gaps between the LDs 108b, the higher resolution of the processor's interpretation of the light transmission data, and, thus, the higher the accuracy of the measurement of the depth of the oil spill at the situs of the device 101 at the time of measurement. The placement of the LDs 108b can be irregular on the first or second sensor column 106, 109 as long as the processor has in its memory the information of the position on the first or second sensor column 106, 109 of each LD 108b. Alternatively, the LDs 108b may be placed in a regular pattern along the length of the first or second sensor column 106, 109. The size of the manufactured LD108b can limit the minimum distance between the LDs 108b as when, for example, the LDs 108b having a diameter of, for example, 10 mm are used. In this example, the closest that the LDs 108b can be placed to one another is one per cm.

However, the LDs 108b can be configured to receive light from the light source 108a by way of a fiber optic cable such that individual light-collecting ends of respective fiber optic cables can be positioned along the length of the first or second sensor column 106, 109 where the light-collecting ends face the light sources 108a. In this manner, one of ordinary skill in the art can manufacture an optic sensor column having light detection points that are less than a single millimeter apart through multiple centimeters apart; from about 1 mm to about 5 cm apart, from about 1 mm to about 4 cm apart, up to about 3 cm apart, up to about 2 cm apart, up to about 1 cm apart, from about 1 mm to about 9 mm apart, from about 1 mm to about 8 mm apart, from about 1 mm to about 7 mm apart, from about 1 mm to about 6 mm apart, from about 1 mm to about 5 mm apart, from about 1 mm to about 4 mm apart, or from about 1 mm to about 3 mm apart. In one embodiment, the LD 108b light-collecting units are about 1 mm, 2 mm, 3 mm, 4 mm, or 5 mm apart.

A suitable LDR is an active optical color sensor that is based on the concept of the variation of intensity and the properties of light propagating through a medium. The amount of received power of light on the receiving surface per unit area is referred to as Illuminance. Blue light exhibits very low absorption in water and high absorption in oil. Blue LEDs are used in this embodiment as the source of light. Because it is preferable that the blue light LD 108b detect wavelengths in a narrow range between about 440 nm and about 490 nm, a particularly suitable receiver was found to be an LDR 108b whose resistance varies inversely (in an exponential fashion) with the change in intensity of the light received on its surface. When the blue light passes through the water, the LDR 108b resistance is relatively low, and when the blue light passes through the oil, the LDR 108b resistance is relatively high. Therefore, a longitudinal array of LED-LDR pairs on the first and second optical sensor columns 106, 109 may be used, through which the change in the resistances of the LDRs 108b can be measured to detect the oil level.

Although this detection method requires the determination of resistances, the actual measurements, in the implemented system design of this embodiment, are voltages. Since the value of an LDR 108b can vary on the order of hundreds, it would be impossible to physically implement a current source to change the LDR 108b resistance to voltage that can be entered to the microcontroller. Therefore, to get the LDRs' 108b resistance values, the voltages (V_{L}) on the LDR 108b were measured using a voltage divider configuration fed with a known voltage (V_{dd}=5 V), where each of the LDRs 108b is placed in series with another resistor Rc, of known value as shown in equation (1), wherein R_{L} is the resistance of the liquid, L. Thus, the resistance of the LDR 108b is calculated using equation (2).

$$\begin{matrix}{V}_{L} = \frac{{V}_{dd} \times {R}_{L}}{{R}_{C} + {R}_{L}} & ( 1 ) \\ {R}_{L} = \frac{{V}_{L}}{{V}_{dd} - {V}_{L}} {R}_{C} & ( 2 )\end{matrix}$$

In order for V_{L} to vary linearly with R_{L} in equation (1), R_{C} should have a very large value. However, this would lead to a very small value of V_{L}, which would be difficult to read using the A/D input of the microcontroller. Conversely, making the value of R_{C} very small makes V_{L} independent of R_{L}, and thus irrelevant to our analysis. Therefore, we have chosen the value of R_{C} to be 1 kΩ, which is in between our range of possible LDR 108b values under different lighting conditions. This enables the device of the present invention to retrieve the LDR 108b resistance values through simple calculations in the microcontroller, using equation (2).

Both the components of the conductivity sensor 107 and the optical sensor 108 are in wired electrical communication with the processor. The conductivity sensor first and second components 107a, 107b are respectively connected via the processor to a voltage and ground when a conductivity measurement is being taken. Thus, an electric circuit is completed by the intervening liquid between the first and second components 107a, 107b and the level of electrical conductivity may be measured. To counteract the detrimental impacts of electrolysis that occurs whenever such a circuit is completed, the processor can be switched to connect the conductivity sensor first components 107a to ground and the conductivity sensor second component(s) 107b to voltage.

All equipment aboard the device 101 requiring electrical power for operation may be powered by a battery, motor, or solar panels. Furthermore, the device 101 may convert mechanical energy associated with wave motion into electrical energy. In general, the device 101 can be powered by any means known to one of ordinary skill in the art. Furthermore, the present invention may be configured to measure the depth of any hydrophobic liquid on the surface of a body of water.

The following describes three exemplary embodiments of the present invention: (1) a device 101 that uses a conductivity sensor 107 to measure the depth of an oil spill; (2) a device 101 that uses an optical sensor 108 to measure the depth of an oil spill; and (3) a device 101 that uses both a conductivity sensor 107 and optical sensor 108 to measure the depth of an oil spill. Each of these embodiments are described with reference to FIG. 1.

In the first of the three exemplary embodiments, to determine whether oil or water is present between a conductive pair, a first electrical voltage (V_{dd}), having a current (I_{dd}), is applied to a fully conducting plate 107b (not visible but disposed, for example, on an unseen surface of the sensor column 109). The oil and/or water between the conductive pair conducts the applied current and a second electrical voltage (V_{R}) is measured at a conducting strip on the second plate 107a. The difference (V_{dd}−V_{R}) between the first and second voltage represents a voltage drop caused by the water and/or oil between the conductive pair.

Ohm's law states that the current through a conductor between two points is directly proportional to a potential difference or voltage drop across the two points and inversely proportional to the resistance between them. According to Ohm's law, a low electrical voltage (V_{R}) at the conducting strip on the second plate 107a corresponds to a high electrical resistance (R_{L}) of the fluid between the conducting pair. Moreover, a high electrical voltage (V_{R}) at the conducting strip on the second plate 107a corresponds to a low electrical resistance (R_{L}) of the fluid between the conducting pair. Water and sea water possess a high conductivity and therefore possess a low electrical resistance. Thus, a high V_{R} value corresponds to the presence of water or sea water between the conducting pair. Oil possesses a low conductivity and therefore possesses a high electrical resistance. Thus, a low V_{R} value corresponds to the presence of oil between the conducting pair.

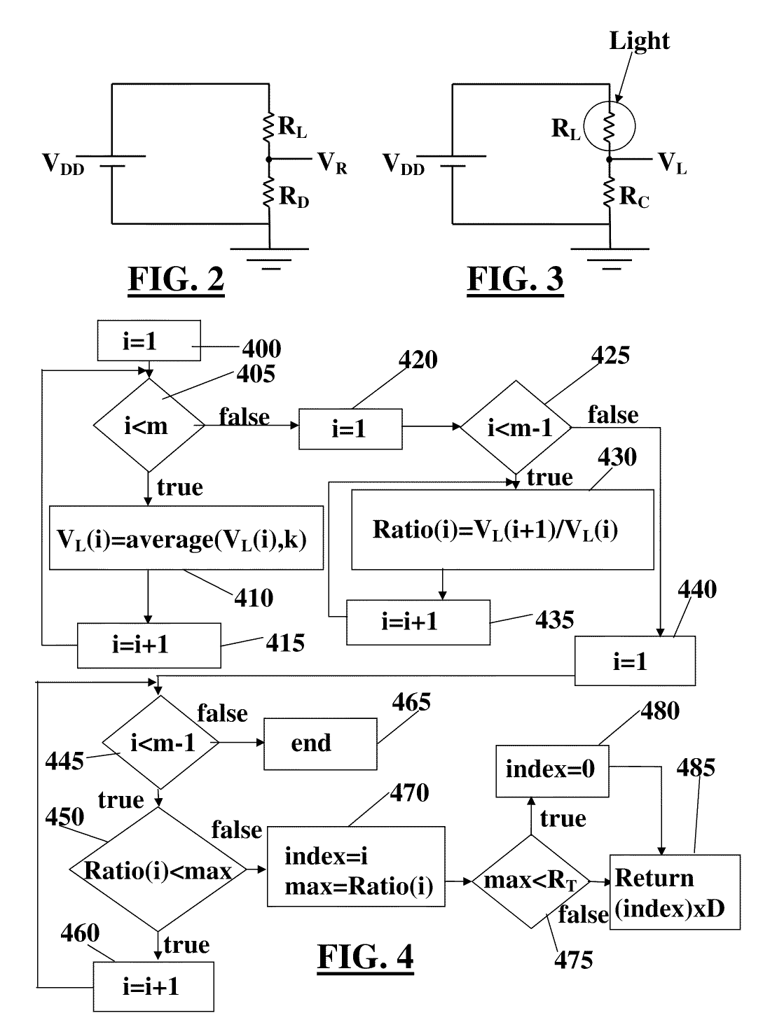

A circuit having one resistor and one voltage source will always have a voltage drop across the resistor equal to the magnitude of the voltage source. Thus, V_{dd} would always equal V_{R}. In order for voltage (V_{R}) at the conducting strip on the second plate 107a to vary in accordance with changes in the resistance (R_{L}) of the fluid between the conducting pair, the conducting pair may be connected in series with a resistor that is connected to ground and has a known electrical resistance of R_{D}. This configuration is known to those skilled in the art as a voltage divider configuration and is shown in FIG. 2. Therefore, the resistance (R_{L}) of the fluid between the conducting pair may be calculated according to equation (3):

R_{L}=(V_{R}*R_{D})/(V_{dd}−V_{R}) (3).

In order to prevent ground looping, which can be caused by the existence of a large number of resistors in series with each conductive strip, the resistors may be connected to a multiplexer, through which only one of the resistors is connected to ground at the same time. Because the conductivity sensor 107 is submerged in oil and/or water when in use and thus likely prone to voltage changes, clamping diodes are preferably used as a protective measure such that the voltage (V_{dd}) applied at the fully conducting plate 107b does not rise over about 5 V or dip below 0 V.

Each conductive pair is located at a different depth in the oil and/or water, presuming that the device 101 is substantially orthogonal to the water and/or oil surface. By measuring the voltage drop across each conductive pair, the device 101 can detect the presence of oil at a certain depth by identifying a change in conductivity between the conductive pairs.

The distance between the conducting plate 107b on the sensor column 109 and a conductive strip 107a on the sensor column 106 may be optimized such that a voltage of a detectable quantity can be measured at the conductive strip 107a. A large distance between the fully conducting plate 107b and the conductive strip 107a may produce a low current therebetween such that V_{R} would be undetectable. On the other hand, a very small distance between the fully conducting plate 107b and the conductive strip 107a may cause oil to become trapped between the two and produce inaccurate depth measurements. An optimal distance between the fully conducting plate 107b and the conducting strip 107a was found to be between about 4 mm and about 9 mm, more preferably between about 5 mm and about 9 mm, yet more preferably between about 6 mm and about 7 mm. Experiments reported here used a standard 6.5 mm distance between the conducting strips 107a and the fully conducting plate 107b.

Measurements of the voltage (V_{R}) at the conductive strips 107a can be analyzed by a processor such as, but not limited to, a programmable intelligent computer (PIC) microcontroller. The processor may include an analog-to-digital converter, a memory, and other components generally known to those skilled in the art. The processor may also include a clock function that is set to a universal standard, such as GMT, so that the data can be time stamped and compared to like data derived from different units of the device 101 employed at differing locations at the same time, and in so doing determine changes in the oil spill over time.

Furthermore, the processor preferably includes an algorithm for converting the voltage measurements (V_{R}) at the conductive strips 107a into information describing the depth of the oil. For example, the algorithm may first calculate averages of k voltage measurements of V_{R}. The algorithm may set a threshold voltage value V_{T}. The threshold voltage value V_{T} may depend on the value of R_{D}, the conducting material used to construct the fully conductive plate 107b and the conductive strips 107a and the distance between the fully conducting plate 107b and a conducting strip 107a. V_{R} measurements less than V_{T}, corresponding to the presence of oil, may be converted by the algorithm into an OFF signal. V_{R} measurements more than V_{T}, corresponding to the presence of water and/or sea water, may be converted by the algorithm into an ON signal. The algorithm may calculate the depth of the oil by multiplying the number of OFF signals with the distance (D) between two consecutive conductive strips. Quantization error for depth calculations of the oil may equal D/2.

Another example of an algorithm for converting the voltage measurements (V_{R}) at the conductive strips into information describing the depth of the oil is displayed in FIG. 4 and consists of the following. The algorithm calculates averages of k voltage measurements of V_{R} at a conductive pair as shown in step 410. This step is repeated for each conductive pair as shown by steps 400, 405, and 415. The algorithm then calculates ratios by dividing a V_{R} measurement for a first conductive pair with a V_{R} measurement for an adjacent conductive pair that is physically directly above the first conductive pair as shown in steps 425, 430, and 435. The maximum of these ratios corresponds to the pair of consecutive conductive pairs where an oil-water boundary exists. This is because the numerator of the ratio, which represents the V_{R} value at the conductive pair submerged in water, will be very large compared to the denominator of the ratio, which represents the V_{R} value at the conductive pair submerged in oil. The algorithm determines the maximum ratio in steps 445, 450, 460, and 465. In order to detect the case where no oil exists between the conductive pairs, in steps 475 and 480 the algorithm may check if the maximum ratio is larger than R_{T}, which may be set to approximately 5. Each conductive pair is preferably numbered consecutively wherein the conductive pair with identification number 1 is located at the surface of the oil and/or water contacting the atmosphere. The algorithm may calculate the depth of the oil by multiplying the conductive pair's identification number where the oil-water boundary exists with the distance (D) between consecutive conductive pairs as shown in step 485. Quantization error for depth calculations of the oil generally equals D/2.

The device preferably also includes a global positioning system (“GPS”) module for determining the geographic location of the device such as, but not limited to, the EM-406 manufactured by GlobalSat. In one embodiment, the GPS is connected to the processor as shown in FIG. 7. Information regarding the location of the device at a moment in time may be combined with information describing the depth of the oil at the same moment in time. The combination of such information may be used to generate a map of the depth of an oil spill at different locations.

The GPS module includes a suitable processing chip for implementing its function. In one embodiment, the GPS module incorporates a SirfStar III chip. The GPS module is preferably small in size, having dimensions such as about 3×3×3 cm, and may have a built-in antenna. GPS modules are designed with respect to different protocols of communication, such as the world standard NMEA-0183 ASCII protocol. A preferred GPS module has a continuous update system that constantly sends different commands to a listener with information about its position and satellite location. That stated, a GPS module that has a discontinuous update system regarding its position and satellite position would still be usefully employed in the present invention. The GPS module preferably requires about a 5 V supply and communicates through suitable ports, such as full duplex RX/TX ports. Having stated that, the present invention can be adjusted for differing power supply needs and communication ports, which are differences that do not impact the overall composition of the invention.

The device includes a transceiver that is connected to the processor. In one embodiment, the connection between transceiver and processor is as shown in FIG. 7. The transceiver, as its name implies, serves to receive and send signals wirelessly. An example of a transceiver usefully employed in the context of the present invention is the TRM-315-LT Evaluation Board. The transceiver includes an antenna for transmitting and/or receiving information, or an antenna is otherwise provided for the purpose. The transceiver transmits information regarding depth measurements of the spilled oil from the processor and geographic location measurements from the GPS module to a remote computer. The remote computer preferably compiles information from a plurality of devices measuring the depth of an oil spill at different locations to generate a map of a depth profile of the oil spill. Furthermore, the transceiver may transmit such information wirelessly in real-time or delayed in time, and, preferably, includes a time record for generation of the data. A real-time transmission of information is a transmission of the information occurring rapidly after the information is obtained. Alternatively, the transmitted data is time stamped by incorporation of a time stamp from a signal from an onboard time keeping element, such as an internal clock on the processor, if it has one and it is functioning, or a clock signal received by the GPS module or the transceiver, as further discussed below.

The transceiver may transmit modulated data signals in a suitable frequency band as known in the art, such as the 433 MHz band, to establish a working wireless communication link between a remote computer and the processor. While the 433 MHz band was employed in an embodiment actually reduced to practice, it is the case that any frequency band used in data transmission or other categories of suitable transmissions is also usefully employed in the context of the present invention. The transceiver may support on-off keying and has a two-wire communication using a transmit/receive (“T/R”) select and a data pin, as known in the art. Data are preferably transmitted continuously, where such transmission is independent of the transceiver's other functions. The two-wire communication is preferably directed at continuous real-time receiving of data from both the optical sensor and the conductivity sensor thereby allowing transmission to the remote computer data that includes simultaneous optical and conductivity data. Communication between the transceiver and the remote computer is accomplished through a suitable channel of transmission, such as a half-duplex channel. A suitable communication protocol is employed, such as the MODBUS communication protocol, which is preferably implemented to use predefined commands of control and built-in error detection facility (i.e., a cyclic redundancy checker (CRC check)). This set-up allows the transceiver to accept data from the processor through an ET-PIC stamp module, for example, and to send timely information about the location and the thickness of the oil in real-time.

In one embodiment, the transceiver employed is a dual-band wireless device that includes two separate wireless transceiver circuits configured to transmit and receive signals using different frequency bands. One usefully employed design for the dual-signal transceiver is set forth at US 2004/0204037, which is incorporated herein by reference in its entirety; other designs of dedicated dual-signal transceivers are well known in the art. In yet other embodiments, the transceiver employed is capable of multiple band communications of three or more bands. For example, the transceiver can communicate using multiple frequency bands where the signals are maintained by quadrature conversion transmitter and receiver circuits as set forth, e.g., at U.S. Pat. No. 6,754,508, which is incorporated herein by reference in its entirety, without limitation intended. Accordingly, using multi-band transceivers of two or more bands, the transceiver can transmit the sensor data as well as receive a clock signal, for example. The clock signal so received can serve as a back-up mechanism (to the clock function in the processor or the GPS module, for example, in those embodiments where these components include a clock function) for assuring that the data from one device unit of the present invention is time-stamped in the same fashion as the data from a second such device unit.

The device of the present invention can include an optional camera 116 whose lens and image capturing component is attached to a portion 117 of the device that remains or extends above the water and/or oil surface. Preferably, the camera components are small, as set forth, for example, in US 2009/0046200, which sets forth an image capture device with detachable expansion unit and is incorporated herein by reference in its entirety. Of course, other designs for an image capture device are well known in the art.

The lens may become fouled by oil, as one might expect given the intended use of the device. Accordingly, the lens at the time of employment is preferably covered with a material that is mechanically removed or torn to reveal the lens after the device has been placed into the oil spill surface at a time point that the camera is desirably employed. The removal of the material can be accomplished by a connecting element (not shown) that removes or tears it by motorized action, controlled by the processor, employing connections and control circuits that are well-known in the art. Alternatively, or in addition, the lens can be cleansed as needed by action of a spray nozzle 118 directed to spray an oil-dissolving solvent from a spraying unit 119 that is, in one embodiment, attached proximate to the camera 116. The placement of the spraying unit is not limited to positions proximate to the spray nozzle 118 as the spraying unit can be attached anywhere on or in the device so long as it is in electrical communication with the processor and contains (i) either its own power source (not shown) or an electric connection to the processor that enables reception of power, (ii) a motorized pump (not shown), (iii) a motor (not shown), and (iv) a reservoir of oil-dissolving solvent (not shown) that is in fluid communication with the spray nozzle 118. The motorized pump can be of any suitable design known to the art for pumping an oil-dissolving solvent, including, without limitation intended, a peristaltic pump that manipulates a tube that is flexible at least in the portion thereof that is in contact with the peristaltic pump and enables the fluid communication between the aforementioned solvent reservoir and the spray nozzle. In one embodiment, the spraying unit 119 is contained within the waterproof enclosure 115. The spraying action can be controlled by the processor to spray solvent upon detecting a lower than expected light level during daylight hours or set to spray solvent automatically at a set interval, either of which mechanisms are well understood in the art including the mechanics and control circuits allowing for processor control.

The camera image capturing system can be sensitive to the visible light spectrum or the infrared spectrum or both. In response to a signal from the processor, the camera can scan the surface to the horizon and the transceiver can transmit the images to the remote computer. These images would be time stamped just as the other data and, in one scenario, reviewed in concert with the other data.

In one embodiment, the portion 117 to which the camera lens and image capturing component is connected can extend upward in, for example, a telescoping set of elements (not shown) driven by a motor (not shown) and controlled by the processor so that the extent of field of vision can be increased. In yet another embodiment, portion 117 includes a rotatable element to which the camera is connected, which rotatable element is driven by a motor that is connected electrically to the processor. Accordingly, the processor can instruct the motor to rotate the rotatable element and thereby turn the camera lens and image capturing component and thus the direction of the field of vision so that differing fields of view can be captured and transmitted.

Preferably, the direction of view of the field is determined by coordinated signal functions from the GPS module that can determine a direction of movement of the device and thereby the direction of the field of view can be determined as compared to the direction of movement. Alternatively, or in addition as a purposeful redundant mechanism of position identification, data from an on-board compass can be included with the transmitted images, which compass is another optional component of the device of the present invention.

In addition to analyzing measurements from the conductivity sensor, the processor may control the transceiver, the GPS module, the conductivity sensor, the optional camera, the optional sprayer, and the optional motor for rotating the camera. The processor may also control the current flowing through each conductive pair, one at a time, in order to capture precise data. The PIC microcontroller may control transistors that are used to turn the conductivity strips 107a on and off in order to measure corresponding voltage levels (VR). Apart from the conductive pairs 107a-b, the camera 116, the motor for rotating the camera (not shown), the sprayer unit 119 (collectively, external electronic components; the optical sensor unit as further described below is also an external electronic component), the noted electronic components (not individually shown in FIG. 1 at 114) are housed in the water-proof enclosure 115. However, the external electronic components are each connected electrically to the processor by wires 110, 111, 112, 113, and 120 (where the line indicated by 120 is two or four wires, depending on whether the sprayer unit is included as an external or internal component, if included at all). In an alternative embodiment, one or more of the external electronic components can be in communication with and controlled by the processor by a wireless protocol, using Bluetooth® technology, for example; in that case, the external electronic components not in wired connection to the processor would have a wired connection to a power source that can be the same power source included in the waterproof enclosure 115 or a separate power source (not shown).

The transceiver also preferably receives information and/or instructions from a remote computer. The processor uses this information and/or instructions to control the transceiver, GPS module, and/or conductivity sensor; and/or camera, sprayer unit, and motor for rotating the camera, if included with the device. For example, a remote computer may transmit instructions to the transceiver for the processor to conduct specific types of measurements and/or to check diagnostics of the device's electrical systems and/or to capture images generally or in a specific direction and/or to spray the lens of the camera.

The device provides accurate measurements of oil depth that are unaffected by external conditions such as wave conditions, lighting conditions, salinity conditions, temperature conditions and/or wind conditions. The conductivity sensor includes no physically moving parts and therefore is unaffected by the jostling caused by wave and/or wind conditions. Furthermore, the device 101 has a center of gravity located substantially below the surface of the oil and/or water. This minimizes tipping of the device caused by large waves and consequently permits the conductivity sensor to remain in a position substantially perpendicular to the surface of the water and/oil. In this position, accurate measurements of the depth of the oil may be taken by the conductivity sensor.

In the second of the three exemplary embodiments, FIG. 1 considered in the absence of the conductivity sensor components 107a, 107b, illustrates an embodiment of the invention that uses an optical sensor 108 to measure the depth of the oil. In this embodiment, the light source 108a is a light emitting diode (LED) and the light receiver 108b (not shown) can be a light dependent resistor (LDR). A LED 108a and LDR 108b located on an axis parallel to the surface of the oil and/or water contacting the atmosphere shall hereinafter be referred to as an LED-LDR pair. The term LED-LDR pair also refers to an embodiment of the present invention where the light source is a single LED 108a extending along the entire length of the first or second sensor column 106, 109. An individual LDR 108b does not need to be the exclusive recipient of light from a LED 108a in order for the device to make accurate measurements. Each LDR 108b can, for example, receive light from a single LED 108a. Also, the light source is not limited to a LED 108a and can be any light source generally known to those skilled in the art. Furthermore, the light receiver is not limited to a LDR 108b and can be any device, generally known to those skilled in the art, whose conductive properties measurably change in the presence of light. Another example of a device suitable for the light receiver is a photodiode.

The light source should emit light of sufficient intensity that it can pass through oil and reach the light receiver with adequate intensity such that any variation in transparency and/or opacity due to the oil is detectable. The color of the light source can be that of any of the visible or near-visible wavelengths that can be suitably detected by an LDR 108b or other light detector. In this embodiment, a blue-emitting LED 108a is used because blue light exhibits very low absorption in water and high absorption in oil. The LDR 108b selected for this embodiment detects wavelengths in a narrow range between 440 nm and 490 nm. The LDR's 108b resistance varies inversely (in an exponential fashion) with the change in intensity of the light received on its surface.

The light sensor has a plurality of LEDs 108a arranged longitudinally along the first sensor column 106 that is substantially perpendicular to the surface of the oil and/or water contacting the atmosphere. The light receiver has a plurality of LDRs 108b arranged longitudinally along the second sensor column 109 that is substantially perpendicular to the surface of the oil and/or water contacting the atmosphere. The resulting LED-LDR pairs may each be disposed at different depth in the water and/oil. The LED-LDR pairs are substantially evenly spaced such that the distance (D) between each LED-LDR pair is substantially the same.

The resolving power (i.e. the smallest change in the thickness of the oil that can be detected) of the optical sensor is directly correlated to the spacing of the LDRs 108b. In an embodiment where the LDRs 108b are arranged adjacent to one another along the longitudinal axis of a sensor column, the number of LDRs 108b that can fit on the sensor column is limited by the width of each LDR 108b. Thus, the resolving power of the optical sensor may be limited by the width of the LDR 108b. In another embodiment, optical fibers can be arranged along the longitudinal axis of a sensor column to receive light from the light source. These optical fibers can be connected to the LDRs 108b which may be located elsewhere on the device. Since the optical fibers can be manufactured with very small widths, a substantial number of optical fibers can be arranged along the longitudinal axis of a sensor column. Thus, using optical fibers to receive light from the light source can result in a high resolving power of the optical sensor that is no different than the theoretical resolving power of the conductivity strips that can be 1 mm apart from one another.

To determine whether oil or water is present between a LED-LDR pair, the light sensor measures the amount of electrical resistance produced in the LDR 108b by the light emitted from the LED 108a. The electrical resistance of a LDR 108b varies inversely with the change in intensity of light incident on its surface. For example, blue light exhibits low absorption when propagating in water and/or sea water and high absorption when propagating in oil. Therefore, blue light emitted by a LED 108a that propagates through oil will have a lower intensity upon reception at the LDR 108b than if the blue light had propagated through water and/or sea water. Since the electrical resistance of a LDR 108b varies inversely with the change in intensity of light incident on its surface, a LDR 108b will have a lower electrical resistance if the blue light has propagated through oil rather than water and/or sea water.

A method for measuring the electrical resistance of the LDR 108b comprises connecting the LDR 108b in series with a resistor, voltage source, and ground. This configuration is known to those skilled in the art as a voltage divider configuration and is shown in FIG. 3. The voltage source has a known voltage (V_{dd}) and the resistor has a known electrical resistance (R_{C}). The voltage (V_{L}) on the LDR is measured and outputted to a processor. The resistance (R_{L}) of the LDR may be calculated according to equation (4):

R_{L}=(V_{L}*R_{C})/(V_{dd}−V_{L}) (4)

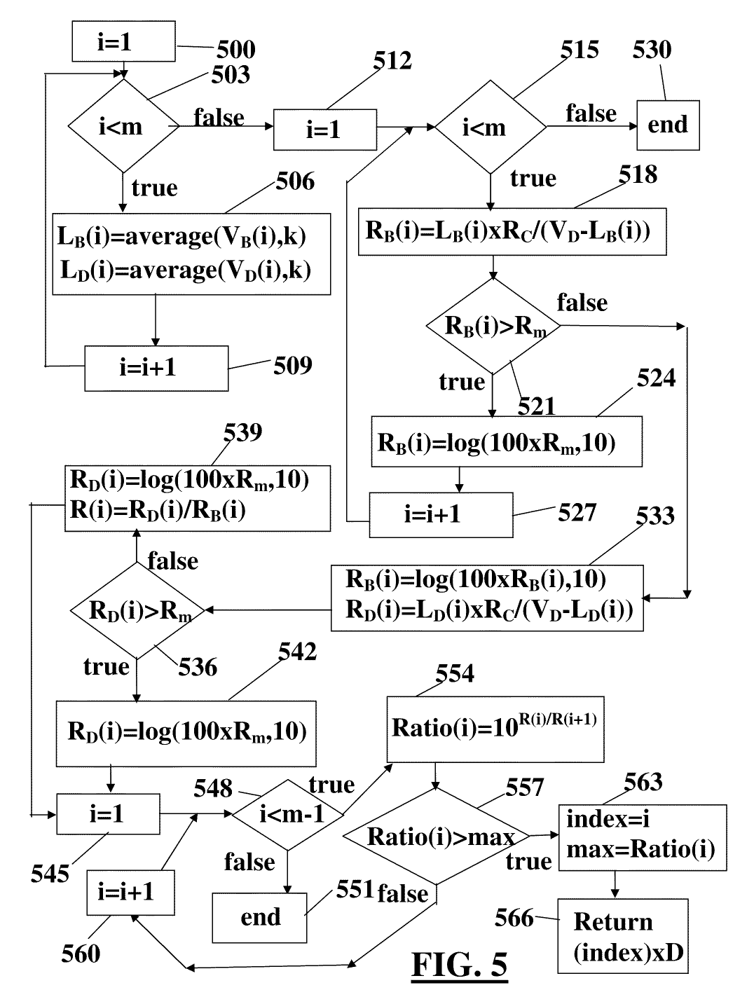

Measurements of V_{L} may be analyzed by a processor such as, but not limited to, a programmable intelligent computer (PIC) microcontroller. The processor may include an analog-to-digital converter, a memory, and other components generally known to those skilled in the art. Furthermore, the computer may include an algorithm for converting the voltage measurements (V_{L}) at the LDRs 108b into information describing the depth of the oil. For example, as shown in FIG. 5, one algorithm usefully employed in the present invention first calculates averages of k voltage measurements of V_{L} at each LED-LDR pair as shown in step 506. This step is repeated for each LED-LDR pair as shown by steps 500, 503, and 509.

Next, the algorithm calculates LDR 108b resistance (R_{L}) values from corresponding voltage measurements (V_{L}) using equation (4) as shown in step 518. Since a small error in voltage measurements (V_{L}) may produce a large change in LDR 108b resistance (R_{L}) values, the algorithm may replace all R_{L} values larger than R_{M}=1 MΩ with 1 MΩ, which may be 1000 times larger than R_{C} as shown in step 521. Next, the algorithm calculates the logarithm of each R_{L} value in order to account for the exponential response of LDRs 108b with change in intensity as shown in step 524 and 527. Then, the algorithm determines a ratio of LDR 108b resistances between the case when the LEDs 108a are emitting light (R_{D}) and when the LEDs 108a are not emitting light (R_{B}) as shown in step 533. This may remove an offset in resistance values, caused by changing lighting conditions, and may eliminate the need for on-site calibration of the LDRs 108b before detection.

The algorithm then divides a ratio calculated at a LED-LDR pair with the ratio calculated at an adjacent LED-LDR that is physically directly above it as shown in step 539. Changes between the ratios may be enlarged using an exponential as shown in step 554. The maximum of these ratios, calculated in steps 554 and 557, corresponds to the pair of consecutive LED-LDR pairs where the oil-water boundary exists. Each LED-LDR pair is numbered consecutively wherein the LED-LDR pair with identification number 1 is located at the surface of the oil and/or water contacting the atmosphere. The algorithm may calculate the depth of the oil by multiplying the LED-LDR pair's identification number where the oil-water boundary exists with the distance (D) between consecutive LED-LDR pairs as shown in step 566. Quantization error for depth calculations of the oil equals D/2.

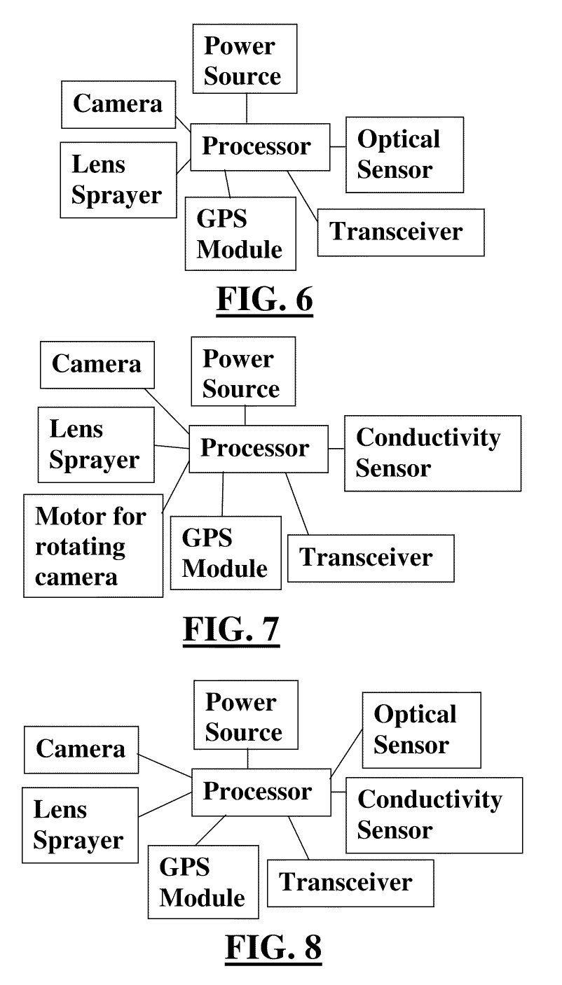

The device 101 also includes a processor that controls the GPS module, a transceiver, an optional camera, an optional spray unit, an optional rotatable element and motor for rotating the camera no different than that described above in the context of the first of the three exemplary embodiments, which description is appropriately incorporated here with regard to the second of the three exemplary embodiments as well. These components are connected as set forth in FIG. 6. One additional aspect of the processor's control in the context of the second of the three exemplary embodiments is that the device 101 may control the intensity of light emitted by each light source of the optical sensor.

The device 101 may provide accurate measurements of oil depth that are unaffected by external conditions such as wave conditions, lighting conditions, salinity conditions, temperature conditions and/or wind conditions. The optical sensor 108 includes no physically moving parts and therefore is unaffected by the jostling caused by wave and/or wind conditions. Furthermore, the device 101 has a center of gravity located substantially below the surface of the oil and/or water. This minimizes tipping of the device caused by large waves and consequently permits the optical sensor 108 to remain in a position substantially perpendicular to the surface of the water and/oil. In this position, accurate measurements of the depth of the oil may be taken by the optical sensor 108.

In the third of the three exemplary embodiments, FIG. 1 illustrates an embodiment of the invention that uses both a conductivity sensor 107, as described in the first of the three exemplary embodiments, and an optical sensor 108, as described in the second of the three exemplary embodiments. The combination of the conductivity sensor 107 and the optical sensor 108 may provide more accurate measurements of the oil depth than using either sensor alone. For example, whenever none or all of the LED-LDR pairs are covered with oil, the algorithm may compute a maximum ratio of LDR 108b resistances at some random LED-LDR pair rather than computing such a maximum ratio for an LED-LDR pair located at the oil-water boundary. Therefore, the optical sensor may not provide an accurate measurement of oil depth in “all-oil” and “no oil” cases. The conductivity sensor is capable of detecting oil depth in the “all-oil” and “no oil” cases. Thus, the combination of the conductivity and optical sensor may provide more accurate measurements of oil depth than using either sensor alone. For a description of the structure and operation of the conductivity and optical sensors, see the first and the second of the three exemplary embodiments, respectively, as discussed previously. FIG. 8 displays the electrical connections between the conductivity sensor 107, optical sensor 108, processor, power source, GPS module, and transceiver.

Hardware Components: The device 101 of the present invention has been described above with respect to what it does, certain algorithms usefully employed for the measurements, and, to an extent, with respect to the various hardware components described with respect to suitable characteristics of each. Turning to a further description of the hardware components, it is noted that the device of the present invention includes the following components described further below with respect to particular instruments and machines, which are presented as examples only and not that the invention is only practiced with respect to the identified examples. In addition to the optical sensor 108 and conductivity sensor 107, the device includes a GPS module, used to locate the geographical position of the device in the oil spill and a radio transceiver, used to transmit the information about the oil spill, including the thickness and position of the oil. It also includes a PIC microcontroller; used to process the measurements collected by the light sensor array and the conductivity array, in order to determine the thickness of the oil, based on the devised detection algorithms (discussed above, and further elaborated upon below).

A suitable GPS module has the following minimum characteristics: multiple channels, low cost, short synchronization time, and built-in antenna. A suitable transceiver has the following minimum characteristics: low power consumption, large transmission range, and a serial interface. A suitable microcontroller has the following minimum characteristics: a compact form, serial port interfaces, and a multi-channel 10 bit A/D converter.

The device prototype was constructed using the following components that met or exceeded the identified characteristics: the EM-411 GPS module manufactured by GlobalSat Technology Corporation (Taipei, Taiwan); the EVAL-315-LT transceiver manufactured by Linx Technologies Inc. (Merlin, Oreg.); the ET-PIC Stamp evaluation kit available from Futurlec (New York, N.Y.), including the PIC18F8722 microcontroller manufactured by Microchip Technology Inc. (Chandler, Ariz.).

Component Integration: For the embodiment that includes both the optical sensor and the conductivity sensor, the microcontroller acquires data from both sensors. In conjunction to reading these data, it also needs to control some devices, such as the light-emitting components of the optical sensor, the transceiver, and the GPS module. One embodiment of the device employs between about eight and about 25 pairs of LED/LDR, another embodiment employs between about 10 and about 20 pairs of LED/LDR, yet another embodiment employs between about 12 and about 18 pairs of LED/LDR. An additional A/D channel of the microcontroller is preferably reserved for the conductivity sensor. The conductivity sensor generally employs a substantially equal number of conductivity strips or plates relative to the number of LED/LDR pairs employed for the optical sensor. The device controls the current flowing through each conductor one at a time in order to potentiate the capture of precise data. The PIC controls an equal number of transistors relative to the conductivity strips that are used in order to turn the conductivity strips on and off needed to measure the corresponding voltage levels. As for measuring, the conductivity plate is connected to the ground through a 4.7Ω resistance and to the A/D input through a protective 1 kΩ resistance. Since the conductivity array is directly in the water and thus may be prone to voltage changes, clamping diodes are used as a protective measure so that the input voltage does not rise over about 5 V or get below 0 V.

The GPS module that was used in one embodiment is the EM-406 from GlobalSat that incorporates a SirfStar III chip. The module size is 3×3 cm and has a built in antenna. It supports different protocols of communication out of which we decided to work with the world standard NMEA-0183 ASCII protocol. The GPS module has a continuous update system that constantly sends different commands to the listener with information about its position and satellite location. It requires a 5 V supply and the communication is through the full duplex RX/TX ports. The 1 PPS is a signal used for clock synchronization since the GPS offers also the current GMT time to the host, needed for synchronous real-time measurements.

The TRM-433-LT transceiver module used in one embodiment transmits modulated data signals in the 433 MHz band to establish a working wireless communication link between a PC and a sensor. The module supports on-off keying and has a two-wire communication using a T/R Select and a Data Pin. On both sides of the communication link, different modules were implemented to interface the PC and PIC with the transceiver boards. The communication is accomplished through a half-duplex channel. The MODBUSS communication protocol was implemented to use the predefined commands of control and the built-in error detection facility (CRC check). The mentioned set-up allows the transceiver to accept data from the microcontroller through the ET-PIC stamp module and to send timely information about the location and the thickness of oil satisfying the real-time requirements of oil sensing.

A preferred embodiment includes as few parts as possible for simplicity and rapid assembly so that the functionality requirements of the sensor are delivered in an easily assembled device. Preferred embodiments employ surface mount device (SMD) technology, as known in the art, in order to minimize the total space occupied by the components. Preferably, the components are selected and employed such that the waterproof enclosure 115 can be as small as possible.

Oil Adhesion: Since the device will be employed in the open ocean or other maritime routes, the molecular attraction exerted between the surface of the device and the spilled oil is not guaranteed, due to the presence of different biological microorganisms. Hence, the direct-contact sensing method necessitates the choice of a material that is much more adhesive to oil than to water. Different materials solve the problem of adhesion on a microscopic level due to their high surface energy, which allows an easier spreading of the oil on a given surface. As an example, oleophilic elastomers (elastic polymers), such as Neoprene and Hypalon, are widely used in the manufacturing of oil skimming products. Broje and Keller, J. COLLOID AND INTERFACE SCI. 305(2): 266-292 (2007). The buoy used to float the sensor is preferably made of an organic polymer that adheres to oil sufficiently to maintain contact with the oil while floating. Another alternative to accomplish strong adhesion to oil onto the device is to cover the top part of the sensor with a feather-like material.

### EXAMPLES

### Example 1

This example was designed to study of the mechanical design of the sensor to assess its stability and the buoyancy of the device in a real-life marine environment.

The Device:

The device tested is constructed substantially in conformity to the design set forth in FIG. 1, with the following exceptions: (1) the conductivity sensor system and the optical sensor system were housed on separate pairs of sensor columns, thus instead of a single pair of sensor columns, the device subject to these examples has two such pairs; (2) no camera system included; (3) no spray nozzle or spray unit included. The other components set forth in FIG. 1 are included, and they are included substantially as configured in FIG. 1.

The device for this example includes an inflatable tube as the flotation structure 104 that is connected to a 20×30×8 cm waterproof enclosure 115 that is made of plexiglass (“the component box”). The component box contains each of three commercially-available electrical boards that function in providing data processing, communication, and GPS data acquisition. The connection between the inflatable tube and the component box is made through four strips of aluminum (1.5 mm thickness) that are wrapped around the inflatable tube in diametrically opposite positions using screws. These strips are connected to each other at the center of the component box from the bottom using a screw.

Four sensor columns are employed, where one pair includes conductivity sensor components and a second pair includes optical sensor components; the columns of each pair are attached to the component box facing one another, and two pairs are configured such that the lines formed respectively between the pairs of sensor columns do not intersect. In other embodiments contemplated by this application, the lines certainly could intersect.

The first conductivity sensor column includes 32 strips of conductive material that are 0.5 cm in width, and each of the 32 strips are separated by an equal width strip of non-conductive material. The 32 conductive strips are numbered in increasing order from top to bottom. Each is separately connected to the processor so that a voltage or ground can be applied to each of the 32 conductive strips individually or in determined combinations as part of the conductivity and oil-depth measurements. The second conductivity sensor column is fully lined with the same conductive material on the surface that faces the spaced strips on the first conductivity sensor column. The conductive material of the second conductivity sensor column is connected to the processor as well and also can be switched between connections to ground and voltage. The center of the first strip is 0.5 cm below the surface of the water. The two conductivity sensor columns are separated by a distance of 6.5 mm. Under the configuration set forth here, the resistance R_{D} as measured upon applying the voltage and ground connections to the conductivity strips and the full-length conductive material on the respective two sensor columns was shown to have a value of 4.7Ω.

The conductive metal used is copper, which was shown to undergo detectable levels of electrolysis during the course of the experiments described here. If used continuously, the copper conductivity strips become worn out due to electrolysis after just a few hours. The electrolysis occurs whenever a conductivity measurement is taken, in which case the conductive strip on the first conductivity sensor column is connected to a 5 V DC voltage and the conductive material on the second conductivity sensor column is connected to ground. In consequence, some cations electrolyze from the conductive strip(s) and stick on the surface of the second conductivity sensor column's full line of conductive material, which is connected to ground. This event lowers the voltage values of further measurements and, ultimately, destroys the conductive strips.

The harm caused to the conductivity strips by such electrolysis is reduced by tinning the copper material of the strips on the first conductivity sensor column and the full length of the second conductivity sensor column. The electrolytic wearing is further reduced through periodic reversals of the voltage and ground connections between the two conductivity sensor columns, which serves to reverse the direction of the electrolysis but does not wholly prevent the harm caused thereby.

The method developed for measuring conductivity of oil and water employs reversing the voltage and ground connections before each conductivity measurement. Accordingly, the first step for a given conductivity measurement involves connecting the 5 V DC voltage to the full length conductive material on the second conductivity sensor column while the specific conductive strip to be used in the instant conductivity measurement is grounded. Taking 30 measurements for each conductive pair successively and repeating this process every 10 minutes increases the life of the conductivity pairs to at least two days of constant use.

The larger the distance between the two conductivity sensor columns, the lesser amount of current in oil will be detected thus rendering more difficult the acquisition of accurate measures. On the other hand, too small a distance could make the oil get stuck between the conductivity sensor columns, which would also produce inaccurate results. The 6.5 mm spacing between the two conductivity sensor columns was empirically shown to achieve sufficient current flow for useful measurements, as indicated below.

The other two sensor columns house the optical sensors, wherein there are 16 LED-LDR pairs aligned along the facing lengths of each, and the centers of each LED and LDR are spaced 2 cm apart. The LEDs each have diameters of 5 mm and the LDRs each have diameters of 10 mm. The LEDs emit a blue light, and the LDRs detect light in the range of about 440 nm to about 490 nm. The distance between a LED and its paired LDR is 7.6 cm. The center of the first LDR is set at the surface of the water under flat sea conditions.

The LEDs are supplied by 4 V (DC) in order that the light source generates enough radiant energy to transmit through the oil and reach its paired receiver with sufficient intensity so that any variation in transparency/opacity due to oil can be detected.

After assembling the whole device shown in FIG. 1 as particularly described here, meaning that unlike in FIG. 1, the two sensor systems were placed respectively on two pairs of sensor columns and the device tested in these examples did not include a camera, spray nozzle, or spray unit, we tested its mechanical design in a large experimental tank with waves. The device was very buoyant and stable and the top of the sensors was exactly at the air-water boundary, even with violent manually-created waves. The maximum tilt of the device with the waves was almost 5 degrees, which is much less than the worst case scenario accounted for above. Moreover, it is worth noting that large oil spills typically form a thick shield over the water with significant surface tension that inhibits the formation of waves, but not totally.

A tank was used for the various experiments where the prototype device was tested in water having a determined quantity of oil. The behavior of the device under different lighting conditions (light and dark), water types (fresh and salt), with and without waves, and under different oil thicknesses was tested using procedures well known in the art and described below further. Algorithms employed:

Algorithm 1 describes the analysis of the measured data using the optical sensor for determining the thickness of the oil. It first takes the averages of k voltage measurements. Then, it calculates the LDR values from the corresponding voltage measurements using equation (2). Since a small error in voltage measurement may produce a large change in the resistance value (V_{L}=4.98; R_{L}=249 kΩ, while V_{L}=4.99; R_{L}=499 kΩ), the algorithm replaces all R_{L} values larger than R_{M}=1 MΩ by 1 MΩ, which is 1000 times larger than R_{C}, and was the maximum resistor value obtained through direct experimental measurement. The logarithm of each resistance is taken to account for the exponential response of LDRs with the change in intensity. This is followed by determining the ratio of the resistances between the case when the blue LEDs are turned off (R_{D}) and when they are turned on (R_{B}). This will remove the offset in the resistance values, caused by changing lighting conditions, and will eliminate the need for on-site calibration of the LDRs before detection. Every one of these ratios R(i) is then divided by its previous one and the changes between these ratios are enlarged using an exponential. The maximum of these ratios corresponds to the pair of consecutive LDRs where the oil-water boundary exists. Therefore, the thickness of the oil is determined with a quantization error equal to D/2, where D is the distance between two consecutive LDRs.

Algorithm 1: Thickness using Optical Sensor:

```
Data: matrix V_{B} and matrix V_{D} of voltages with and
    without blue light respectively,
    V_{dd}, voltage for the voltage divider,
    R_{C}, resistance in series with the LDR,
    D, distance between two consecutive LDRs.
    R_{M}, max possible value for a resistor
Result: Thickness of the Oil (same unit as d)
```

| | |
|---|---|
| Initialization: | Set m to the number of LDR's used |
| | Set k to the number of times each |

```
                      measurement is repeated
          Set max to 0, index to −1.
for i = 1, . . . m do
          L_{B}(i) = average(V_{B}(i),k)
          L_{D}(i) = average(V_{D}(i),k)
end
for i = 1, . . . m do
          ${R}_{B} ( i ) = \frac{{L}_{B} ( i )}{{V}_{dd} - {L}_{B} ( i )} \times {R}_{C}$
        if R_{B}(i) > R_{M} then R_{B}(i) = log(100 × R_{M}, 10)
        else
              R_{B}(i) = log(100 × R_{B}(i), 10)
              ${R}_{D} ( i ) = \frac{{L}_{D} ( i )}{{V}_{dd} - {L}_{D} ( i )} {R}_{C}$
        if R_{D}(i) > R_{M} then
            R_{D}(i) = log(100 × R_{M},10)
        else
            R_{D}(i) = log(100 x R_{D}(i),10)
        $R ( i ) = \frac{{R}_{D} ( i )}{{R}_{B} ( i )}$
end
for i = 1, . . . m-l do
          $Ratio ( i ) = {10}^{\frac{R ( i + 1 )}{R ( i )}}$
        if Ratio(i) > max then
              index = i
              max = Ratio(i)
endreturn (index) × D
```

Algorithm 2 describes the analysis of the measured data using the conductivity sensor in order to determine the thickness of the oil. It first takes the averages of k voltage measurements on R_{D}. Since conductivity measurements change with the water salinity (a conclusion supported by our experimental results), every one of these voltages V(i) is then divided by its previous one and the maximum of these ratios corresponds to the pair of consecutive conductive pairs where the oil-water boundary exists. In order to detect the “no oil” case, the algorithm checks if the maximum ratio is larger than R_{T}, which is usually set to 5. Therefore, the thickness of the oil is determined with a quantization error equal to D/2, where D is the distance between two consecutive conductive strips.

Algorithm 2: Thickness using Conductivity Array:

```
Data: matrix V_{R} of voltages across the resistor in series
    with each conducting pair,
    R_{T}, min threshold ratio,
    D, distance between two consecutive
    conducting strips.
Result: Thickness of the Oil (same unit as d)
Initialization: Set m to the number of conducting pairs
                                      Set k to the number of
                    times each measurement is repeated
          Set index to −1, max to 0.
for i = 1, ...m do
        V(i) = average(V_{R}(i), k)
end for
for i = 1, ...m−1 do
        Ratio(i) = V(i+1)/V(i)
end for
for i = 1, ...m−1 do
        if Ratio(i) > max then
            index = i
            max = Ratio(i)
        end if
end for
if max < R_{T} then
    index = 0
end if
return (index) × D
```

Results:

The experimental results show that for the optical sensor, the results improved with the thickness of the oil, and this was visible through higher peaks and percentage difference values from the closest (second) obtained ratios. This was caused by the shadowing effect of the oil, which decreased the interference from the environment and between the LEDs. Therefore, the experimental design was altered so that the LEDs were turned on successively in groups of four (i.e., LEDs 1-5-9-13 turned on together, then LEDs 2-6-10-14, and so forth) in order to decrease the interference between them.

A. Light vs. Dark Experiments

Experiments for testing the effect of ambient light conditions on the optical sensors were conducted using only the light sensor because the conductivity sensor is not substantially affected by varying lighting conditions. In addition, the light experiments were performed with different thicknesses of oil. The thickness levels examined are 2 cm apart from each other because the resolution of the device is equivalent to the distance between the centers of two consecutive LDRs in the array.

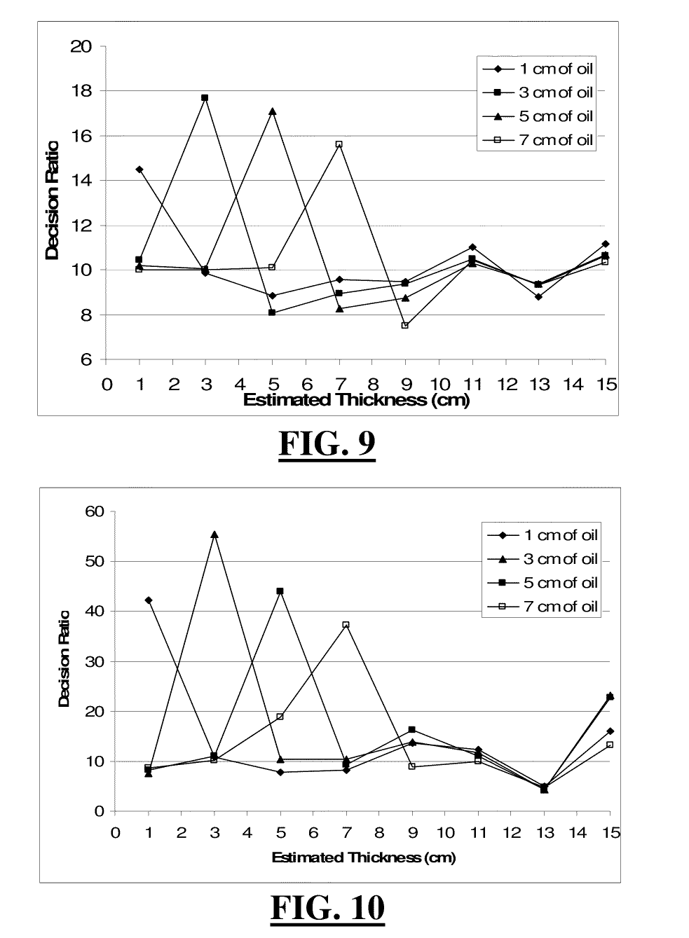

FIGS. 9 and 10 summarize the results of using algorithm 1 with the optical sensor for light conditions and dark conditions, respectively. These graphs show the ratios explained in algorithm 1, where the maximum peaks of these ratios represent the estimated thickness, which can be read on the x-axis of the graph. Each of the three curves, in both FIGS., has its peak at its corresponding thickness read on the x-axis. Therefore, the conducted experiments have not produced any errors. From both FIGS. 9 and 10, one can see that the estimated thicknesses of the oil are accurate in both light and dark conditions.

Table I shows the percentage difference between the peak of each curve and the closest (second) obtained ratio. The table shows that even if the highest ratio, below the maximum ratio, increased due to experimental error by the percentage listed in the table, the results of the algorithm would still have given correct estimates of the thickness.

TABLE I
Percentage Difference Between the Peak of
Each Curve and the Closest Obtained Ratio

| | Light | Dark |
|---|---|---|
| 1 cm | 29.9% | 162.7% |
| 3 cm | 66.4% | 139.0% |
| 5 cm | 60.6% | 93.2% |
| 7 cm | 49.3% | 183.7% |

B. Fresh Water vs. Salt Water Experiments

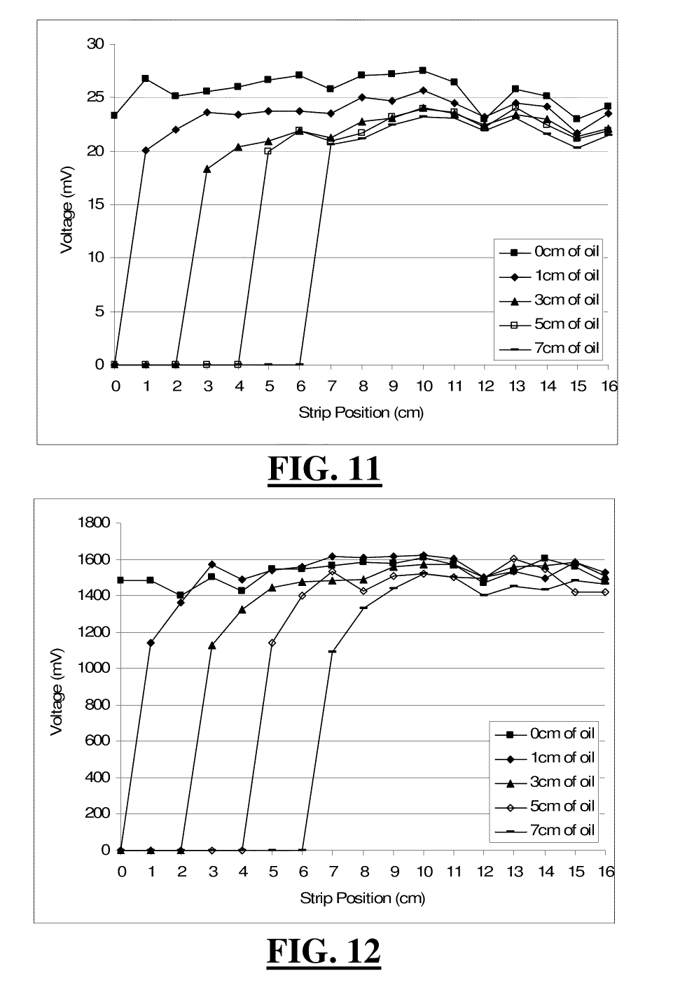

Experiments for testing the effect of water salinity conditions were conducted using only the conductivity sensor because the light sensor is not affected by varying water salinity. In addition, the water salinity experiments were performed with different thicknesses of oil. FIGS. 11 and 12 summarize the results of using algorithm 2 with the conductivity sensor for fresh water and salt water conditions, respectively. These graphs show the ratios explained in algorithm 2, where the strip position at which a maximum ratio is located (given that the ratio is higher than a threshold of about 5) represents the estimated thickness of the oil. FIGS. 11 and 12 demonstrate that the estimated thicknesses of the oil are accurate in both fresh water and salt water conditions. The maximum ratios for the fresh water and salt water experiments are also found in the shaded cells of Tables II and Table III, respectively. These results show no errors.

TABLE II
Conductivity Algorithm Results (Fresh Water)

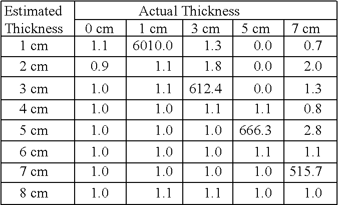

TABLE III
Conductivity Algorithm Results (Salt Water)

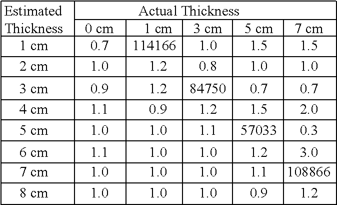

C. Temperature Change Experiments

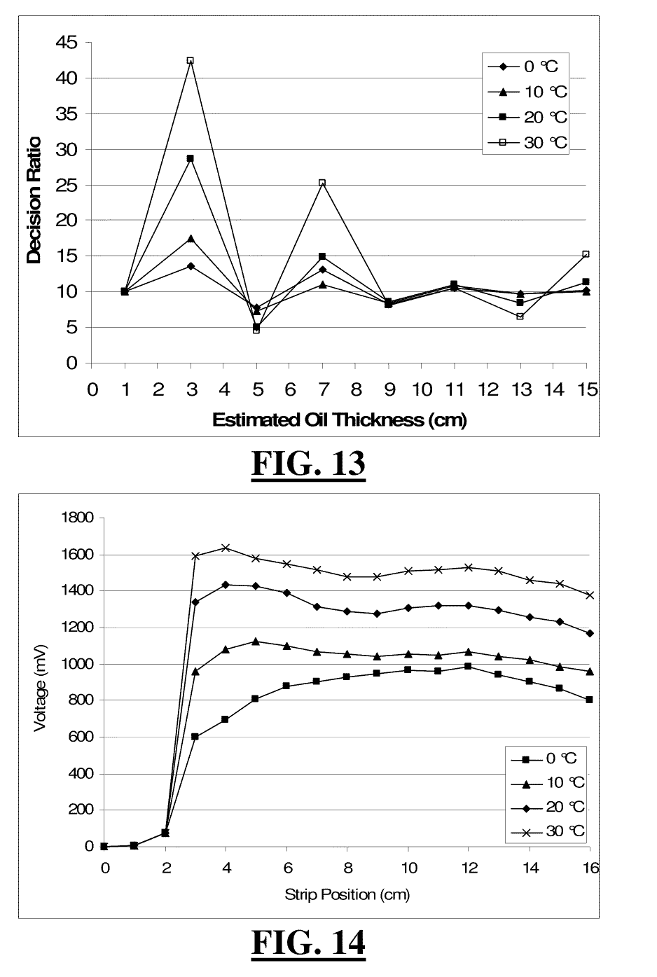

Experiments for testing the effect of temperature conditions were conducted using both the conductivity sensor and the optical sensor. The temperature experiments were performed with a 3 cm thickness of oil. FIGS. 13 and 14 summarize the results for the optical sensors and conductivity sensors, respectively. One can conclude from FIGS. 13 and 14 that both the optical sensor and the conductivity sensor are more accurate at high temperatures. Table IV shows the percentage difference between the peak of each curve and the closest (second) obtained ratio, obtained by algorithm 1, for the optical sensor. Table IV shows that even if the highest ratio, below the maximum ratio, increased due to experimental error by the percentage listed in the table, the optical sensor's estimated thicknesses would have still been accurate. Table V shows the maximum ratios, calculated by algorithm 2, in shaded cells for the conductivity sensor. These results show no errors.

TABLE IV
Percentage Difference Between the Peak of Each Curve
and the Closest Obtained Ratio (Changing Temperature)

| | |
|---|---|
| 0° C. | 4.3% |
| 10° C. | 60.1% |
| 20° C. | 92.2% |
| 30° C. | 67.6% |

TABLE V
Conductivity Algorithm Results (Changing Temperature)

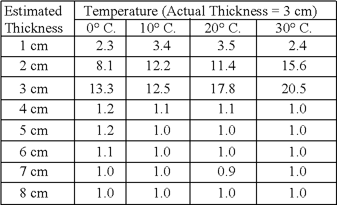

D. Wave Experiments

Experiments for testing the effect of waves were conducted using both the conductivity sensor and the optical sensor.

### (1) Wave Experiments with Optical Sensor

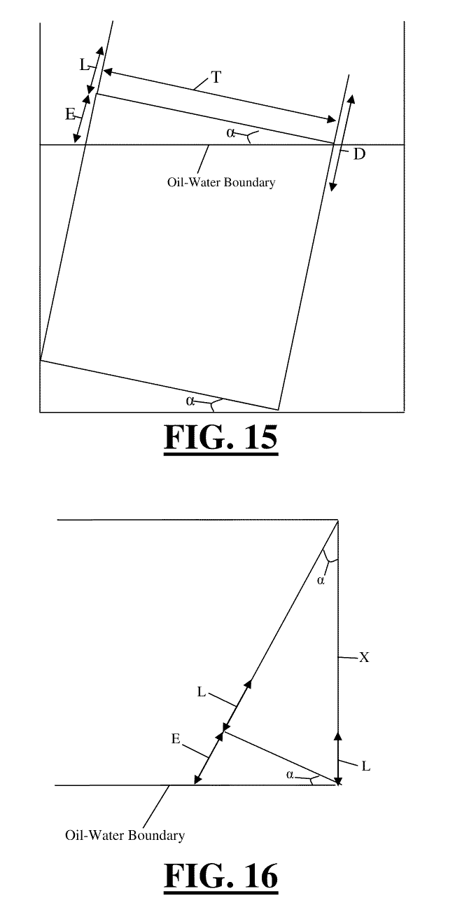

The following is an analytical error analysis of the optical sensor when it is moving back to front in the presence of waves. In FIG. 10, D is the separation distance (cm) between 2 consecutive LDR centers' strips, T is the distance between an LDR and an LED (cm), and L is the difference between the Oil-Water Boundary and the first LDR above it. For a Back-to-Front or Front-to-Back tilt as seen by α on FIG. 15, the worst case error in the thickness measurement is calculated by equation (5).

$$Error = ceiling \{ \frac{T \times tan α + L - \frac{D}{2}}{D} \} \times D \qquad ( 5 )$$

The error is divided by D, the ceiling is taken, and it is multiplied back by D in order to round it up to the nearest multiple of D, which is the resolution of the sensor. This rounding is needed since in the worst case, the detection method results in an error in the measurement as soon as the first LED-LDR pair below the oil-water boundary touches the oil.

The following is the error analysis when the array is tilting from right to left with the waves. For a Left-to-Right or Right-to-Left tilt as seen by α in FIG. 16, perpendicular to the surface of FIG. 15, the worst case error in the thickness measurement is calculated by equation (6).

$$Error = ceiling \{ \frac{X \times tan α \times sin α + L - \frac{D}{2}}{D} \} \times D \qquad ( 6 )$$

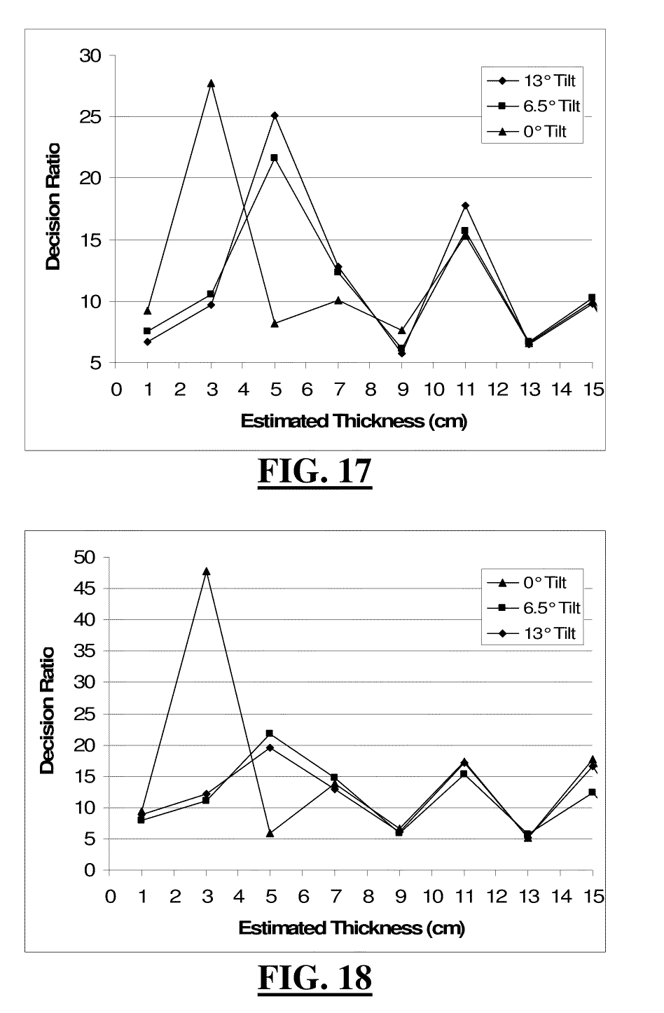

FIGS. 17 and 18 summarize the results of the simulated wave experiments which were conducted with an oil thickness of 3 cm. FIG. 17 represents the results for right-to-left tilt of the optical sensor and FIG. 18 represents the results for the back-to-front tilt of the optical sensor. In these experiments the device was first tilted from back to front and then from right to left. After the device was tilted, measurements were taken. In both FIGS. 17 and 18, whenever there is a tilt, oil thickness is estimated incorrectly by one resolution unit (2 cm). However, averaging several measurements and then applying algorithm 1 solves this problem. Thus, these experiments represent the worst case scenario of wavy conditions where the sensor is assumed to not be stable.

### (2) Wave Experiments with Conductivity Sensor

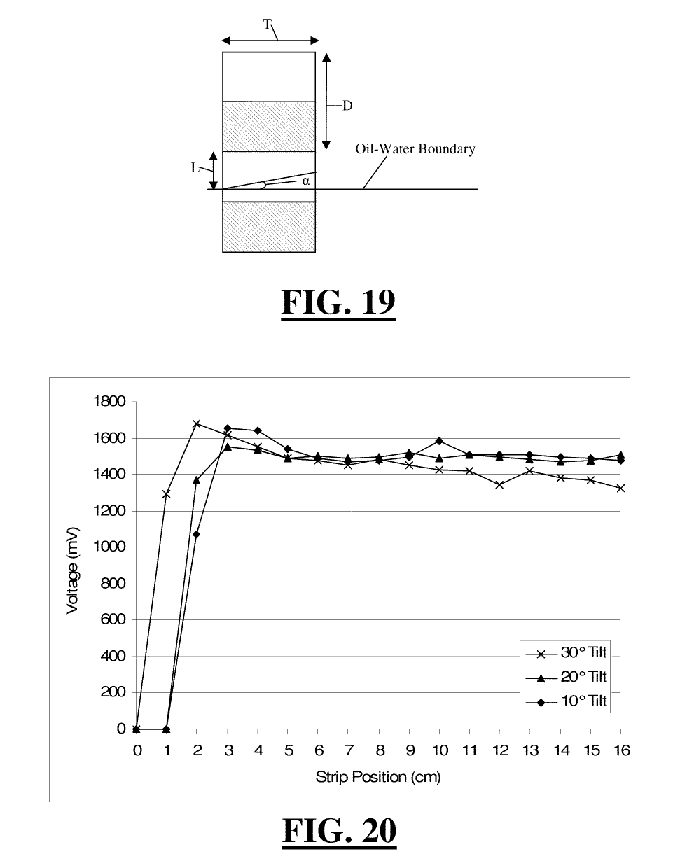

The following analytical error analysis of the conductivity sensor when it is moving back to front in the presence of waves. In FIG. 19, the shaded strips represent the conductive strips, while the white strips represent the nonconductive strips. Here, D is the separation distance (cm) between two consecutive conducting strips, T is the width (cm) of each strip, S is the separation distance (cm) between the fully-conductive plate and the stripped plate, and L is the difference between the oil-water boundary and the first conductive strip above it.

For a Back-to-Front tilt perpendicular to the surface of FIG. 19, the worst case error in the thickness measurement is calculated by equation (7).

$$Error = ceiling \{ \frac{S \times tan α - L + \frac{D}{2}}{D} \} \times D \qquad ( 7 )$$

Moreover, for a Left-to-Right or Right-to-Left tilt as seen by a in FIG. 19, the worst case error in the thickness measurement is calculated by equation (8).

$$Error = ceiling \{ \frac{T \times tan α - L}{D} \} \times D \qquad ( 8 )$$

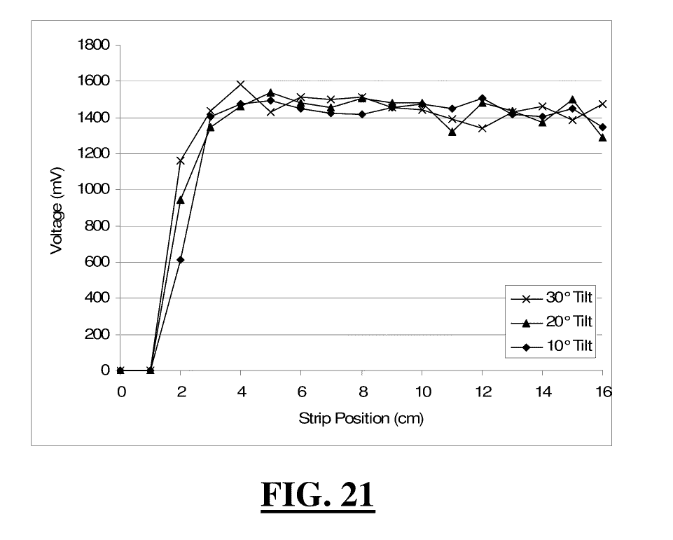

FIGS. 20 and 21, along with Tables VI and VII summarize the results of the simulated wave experiments for the conductivity sensor. FIG. 20 represents the results for right-to-left tilt of the conductivity sensor and FIG. 21 represents the results for the back-to-front tilt of the conductivity sensor. In these experiments the device was first tilted from back to front and then from right to left. After the device was tilted, measurements were taken. In both FIGS. 20 and 21, whenever there was a tilt, the thickness was estimated incorrectly by one resolution unit (1 cm), except in one case, where the error was two resolution units. As in the case for the optical sensor, this problem can be solved and these experiments represent the worst case scenario.

TABLE VI
Conductivity Algorithm Results (Right To Left Waves)

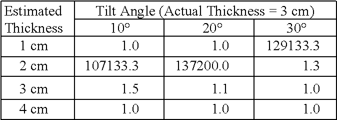

TABLE VII
Conductivity Algorithm Results (Back to Front Waves)

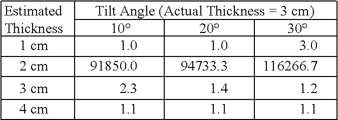

### (3) Summary of Wave Experiment Results

Whenever none or all of the LDRs are covered with oil, algorithm 1 will compute a maximum ratio at some random thickness thereby producing an incorrect result. Unlike the conductivity sensor, the optical sensor is not suitable for the “no oil” and the “all-oil” cases. Moreover, the conductivity sensor has a better resolution than the optical sensor. Nevertheless, the resolution of the optical sensor is improved by reducing the distance between the centers of the LDRs and/or by using smaller LDRs, as further discussed above in the Detailed Description of the Invention as well as in the following example. It was found that in the absence of cleaning efforts, the resolution of the optical sensor was approximately 2 cm. The resolution of the conductivity sensor was found to be about 1 mm.

Even with violent manually-created waves, the device was found to very buoyant and stable. Additionally, the tops of the sensor columns were found to be level with the air-water boundary even in the presence of waves. The maximum tilt of the device with the waves was approximately 5 degrees, which is much less than the worst case scenario discussed above. Moreover, it is worth noting that large oil spills typically form a thick shield over the water with significant surface tension which inhibits the formation of waves.

E. Power Profiling

Since the optical and conductivity sensors used in the device are battery-driven, energy profiling was necessary for the different components of the optical and conductivity sensors. Additionally, energy profiling was necessary to show that the device could be operational over the entire duration of an oil spill cleanup. The running cycle of the device tested was 7080 ms, which satisfies the lifetime requirements of a device having a battery rating of 11,100 mAH and an expected query rate by a base station. The results of the power profiling are shown in Table VII.

TABLE VII
Power Profiling

| State of Operation | Power Consumption (mW |
|---|---|
| Idle | 833 |
| LEDs-OFF | 1725 |
| LEDs-ON | 2321 |
| In-oil Conduct | 1309 |
| Light-array algorithm | 1333 |
| Conductivity algorithm | 1273 |
| Transceiver (TX) | 10 |
| GPS | 220 |

### Example 2

The following example illustrates changes in the resolving power of the optical sensor as the distance between LDRs decreases. As discussed previously, the resolving power of the optical sensor is directly correlated to the position of the LDRs relative to one another. The number of LDRs that can be arranged adjacent to one another along the longitudinal axis of a sensor column is limited by the width of each LDR as employed in Example 1.

The device for this example has the same components as the device discussed in Example 1 except that adjacent LDRs are arranged such that their centers are 1 cm apart (rather than being 2 cm as in Example 1). Each LDR has a diameter of 1 cm. The LDRs are arranged side-to-side along the longitudinal axis of the sensor column such that the centers of adjacent LDRs are 1 cm apart. The resolution of the optical sensor for this example is approximately 1 cm whereas the resolution for the optical sensor in Example 1 was 2 cm. This example illustrates that the resolution of the optical sensor increases as the distance between the centers of adjacent LDRs decreases.

Tests of this configured device shows that the resolving power of the device of this Example 2 approaches about 1 cm, using the same water tank and procedures set forth in Example 1.

A third device is manufactured where individual LDRs are connected to a fiber optic cable having a diameter of 1 mm. Light-collecting ends of the fiber optic cables are attached to the sensor column, where the center of each cable is 1.5 mm apart, facing the light sources on the opposing sensor column, as per FIG. 1. The opposite end of the fiber cable is attached to individual LDRs that are in turn connected to the processor.

Tests of this configured device shows that the resolving power of this second device approaches about 1.5 mm, using the same water tank and procedures set forth in Example 1.

As noted above, the present invention is applicable to monitoring of spilled oil in marine environments. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A device for measuring depth of a hydrophobic liquid on a water surface comprising:
a means for measuring conductive properties of a hydrophobic liquid and water where the hydrophobic liquid is layered above the water;
a means for interpreting a difference in the conductive properties of the hydrophobic liquid and the water with regard to the depth of the hydrophobic liquid ; and
a means for transmitting the depth of the hydrophobic liquid as derived from the measured conductive properties to a receiver.

2. The device of claim 1, further comprising a means for measuring light transmission properties of the hydrophobic liquid and the water, a means for interpreting a difference in the light transmission properties of the hydrophobic liquid and the water with regard to the depth of the hydrophobic liquid; and a means for transmitting the depth of the liquid as derived from the measured light transmission properties to the receiver.

3. The device of claim 2, wherein the means for interpreting a difference in the conductive properties of the hydrophobic liquid and the water with regard to the depth of the hydrophobic liquid and the means for interpreting a difference in the light transmission properties of the hydrophobic liquid and the water with regard to the depth of the hydrophobic liquid are the same and comprise a processor and an algorithm.

4. The device of claim 1, wherein the means for transmitting the depth of the liquid as derived from the measured conductivity or light transmission properties to the receiver comprises a wireless transmission.

5. The device of claim 1, wherein the means for measuring the conductive properties of the liquid comprises a conductivity sensor having a first conductive surface and a second conductive surface wherein the first conductive surface does not contact the second conductive surface.

6. The device of claim 5, wherein the means for measuring the conductive properties of the liquid comprises applying a first voltage to the first conductive surface and measuring a second voltage at the second conductive surface wherein the difference between the first voltage and the second voltage corresponds to the conductive properties of the liquid.

7. The device of claim 6, wherein the second conductive surface comprises a plurality of conductive strips longitudinally arranged along an axis from uppermost to bottommost, wherein each conductive strip is disposed at an increasingly greater depth in the hydrophobic liquid or water.

8. The device of claim 2, wherein the means for measuring the light transmission properties of the hydrophobic liquid or water comprise an optical sensor having a light source and a light receiver, wherein the light receiver receives light emitted by the light source.

9. The device of claim 8, wherein the means for measuring the light transmission properties comprises measuring an electrical resistance produced in the light receiver by the light emitted by the light source, wherein the electrical resistance produced in the light receiver correlates directly to the light transmission properties of liquid that is disposed between the light source and the light receiver.

10. The device of claim 9, wherein the optical sensor comprises a plurality of light sources longitudinally arranged along a first column and a plurality of light receivers longitudinally arranged along a second column, wherein each light source is paired with one or more light receivers at about the same positions on the respective columns, which light receivers are attached to the second column at identified positions of depth.

11. The device of claim 1, further comprising a location sensor that measures geographic location of the device and a means for transmitting geographic location information collected by the location sensor.

12. The device of claim 1, further comprising floatation means to render the device buoyant in a liquid.

13. The device of claim 1, wherein the means for measuring the depth of the liquid is substantially unaffected by ambient conditions of water or atmosphere selected from the group consisting of light, temperature, salinity, wind, water currents, and waves.

14. The device of claim 13, wherein the ambient condition is selected from the group consisting of wind, water currents, and waves.

15. A device for measuring depth of a hydrophobic liquid on a water surface comprising a flotation structure, a substantially waterproof enclosure that is attached to the flotation structure, one or more pairs of sensor columns that are attached to the substantially waterproof enclosure, and electronic equipment contained in the substantially waterproof enclosure.

16. The device of claim 15, wherein the sensor columns house components for a conductivity sensor.

17. The device of claim 16, wherein the sensor columns house components for an optical sensor.

18. The device of claim 17, wherein the electronic equipment is selected from the group consisting of a processor, a controller, a geographic positioning device, and a power source.

19. The device of claim 18, wherein the device includes a camera that captures images from above the flotation device.

20. The device of claim 19, wherein the camera is attached to a rotatable post that facilitates fields of vision in any direction.

21. A method for measuring depth of a hydrophobic liquid on a water surface comprising:
providing a buoyant device with sensor columns in a body of water;
detecting a boundary between the hydrophobic liquid and the body of water wherein the sensor columns extend through the boundary; and
measuring the distance between the boundary and a top surface of the hydrophobic liquid wherein the distance represents the depth of the hydrophobic liquid.

22. The method of claim 21, further comprising the step of wirelessly transmitting the depth of the hydrophobic liquid to a remote computer.

23. The method of claim 22, further comprising the step of measuring the geographic position of the buoyant device.

24. The method of claim 23, further comprising the step of generating a depth profile of the hydrophobic liquid based on depth measurements of the hydrophobic liquid from a plurality of buoyant devices.

25. The method of claim 22, wherein the step of wirelessly transmitting the depth of the hydrophobic liquid to a remote computer is executed in real-time.

26. The method of claim 21, wherein the buoyant device with sensor columns comprises a conductivity sensor, an optical sensor having a light source and a light receiver, and a processor, connected to the conductivity sensor and optical sensor, for processing measurements detected by the conductivity sensor and the optical sensor.

27. The method of claim 26, wherein the light receiver is a light dependent resistor.

28. The method of claim 26, wherein the conductivity sensor comprises a first conductive surface and a second conductive surface where the first conductive surface does not contact the second conductive surface.

29. The method of claim 27, further comprising a plurality of light sources longitudinally arranged along a first axis and a plurality of light receivers longitudinally arranged along a second axis wherein each light source and each light receiver is disposed at a different depth in the hydrophobic liquid.

30. The method of claim 28, wherein the second conductive surface comprises a plurality of conductive strips longitudinally arranged along an axis wherein each conductive strip is disposed at a different depth in the hydrophobic liquid.

31. The method of claim 21, further comprising the step of using an algorithm to filter noise from the depth measurements resulting from lighting conditions, temperature conditions, salinity conditions, and wave conditions.
